(19) United States
(12) Patent Application Publication
(10) Pub. No.: US 2025/0391377 A1
(43) Pub. Date: Dec. 25, 2025

(54) STAGE CIRCUIT AND DISPLAY DEVICE INCLUDING THE SAME, AND ELECTRONIC DEVICE

(71) Applicant: Samsung Display Co., Ltd., Yongin-si (KR)

(72) Inventors: Sang Yong NO, Yongin-si (KR); Kyung Ho KIM, Yongin-si (KR); Sung Ho PARK, Yongin-si (KR)

(21) Appl. No.: 19/205,529

(22) Filed: May 12, 2025

(30) Foreign Application Priority Data
Jun. 19, 2024 (KR) 10-2024-0079890
Nov. 6, 2024 (KR) 10-2024-0156419

(51) Int. Cl. G09G 3/3266; G09G 3/3233

(52) U.S. Cl. CPC G09G 3/3266; G09G 3/3233; G09G 2300/0819; G09G 2300/0842; G09G 2310/08; G09G 2320/0233; G09G 2330/02

(57) ABSTRACT

A stage circuit includes: a driving circuit connected to a first power input terminal configured to receive a first power source and a second power input terminal configured to receive a second power source, the driving circuit controlling a voltage of a first node; first output circuits receiving any one of a plurality of scan clock signals, the first output circuits outputting enable scan signals, based on a voltage of any one of local nodes; and connection circuits connected between the respective local nodes and the first node, the connection circuits controlling electrical connections between the first node and the local nodes, corresponding to a voltage input to a connection control line. The connection circuits electrically connect the first node and the local nodes to each other during a first period in a period in which the first node has a voltage of a first level or higher.

### CROSS-REFERENCE TO RELATED APPLICATION

The present application claims priority to and the benefit of Korean patent application No. 10-2024-0079890 filed on Jun. 19, 2024, and Korean patent application No. 10-2024-0156419 filed on Nov. 6, 2024, in the Korean Intellectual Property Office, the entire disclosures of each of which are incorporated herein by reference.

### BACKGROUND

### 1. Field

Aspects of some embodiments of the present disclosure generally relate to a stage circuit and a display device including the same, and an electronic device.

### 2. Description of the Related Art

With the development of information technologies, the importance of a display device which is a connection medium between a user and information increases. Accordingly, display devices such as a liquid crystal display device and an organic light emitting display device are increasingly used.

A display device may include pixels, and the pixels may receive a data signal, corresponding to a scan signal supplied from a scan driver, and emit light with a luminance corresponding to the data signal. The scan driver may include a plurality of stage circuits to supply the scan signal.

The above information disclosed in this Background section is only for enhancement of understanding of the background and therefore the information discussed in this Background section does not necessarily constitute prior art.

### SUMMARY

Embodiments provide a stage circuit and a display device including the same, and an electronic device, which can minimize a luminance difference in a unit of a horizontal line.

In accordance with an aspect of the disclosure, there is provided a stage circuit including: a driving circuit connected to a first power input terminal to which a first power source is input and a second power input terminal to which a second power source is input, the driving circuit controlling a voltage of a first node; a plurality of first output circuits receiving any one of a plurality of scan clock signals, the plurality of first output circuits outputting enable scan signals, based on a voltage of any one of local nodes; and connection circuits connected between the respective local nodes and the first node, the connection circuits controlling electrical connections between the first node and the local nodes, corresponding to a voltage input to a connection control line, wherein the connection circuits electrically connect the first node and the local nodes to each other during a first period in a period in which the first node has a voltage of a first level or higher, and electrically interrupt the first node and the local nodes from each other during a second period after the first period in the period in which the first node has the voltage of the first level or higher.

The first level may be a logic high level.

The stage circuit may further include a holding capacitor connected between the connection control line and a constant voltage source.

The driving circuit may additionally control a voltage of a second node, and the first output circuits may be electrically connected to the second node.

The stage circuit may further include a holding transistor connected between each of the local nodes and the second power input terminal, the holding transistor including a gate electrode connected to the second node.

The stage circuit may further include a second output circuit connected between a carry clock input terminal to which a carry clock signal is input and the second power input terminal, the second output circuit connecting a carry output terminal to the carry clock input terminal or the second power input terminal, based on the voltage of each of the first node and the second node.

The second output circuit may include: a first carry transistor connected between the carry clock input terminal and the carry output terminal, the first carry transistor including a gate electrode connected to the first node; and a second carry transistor connected between the carry output terminal and the second power input terminal, the second carry transistor including a gate electrode connected to the second node.

Each of the first output circuits may be connected to any one of output terminals, and the second period may be a period in which any one of the scan clock signals is supplied as the enable scan signal to the output terminals in each of the first output circuits.

Each of the first output circuits may include: a first output transistor connected between a scan clock input terminal to which any one of the scan clock signals is input and any one of the output terminals, the first output transistor including a gate electrode connected to any one of the local nodes; and a second output transistor connected between a fourth power input terminal to which a fourth power source is input and any one of the output terminals, the second output transistor including a gate electrode connected to the second node.

The fourth power source may have a voltage higher than a voltage of the second power source.

The stage circuit may further include: a boosting circuit connected between a boosting clock input terminal to which a boosting clock is input and the second power input terminal, the boosting circuit connecting a voltage control line to the boosting clock input terminal or the second power input terminal, based on the voltage of each of the first node and the second node; and a control circuit connected to the first power input terminal, third power input terminal to which a third power source having a voltage lower than a voltage of the first power source is input, and the connection control line, the control circuit controlling a voltage of the connection control line, corresponding to a plurality of carry signals supplied to carry input terminals.

Each of the connection circuits may include: a switching transistor connected between any one of the local nodes and the first node, the switching transistor including a gate electrode connected to the connection control line; and a boosting capacitor connected between any one of the local nodes and the voltage control line.

The boosting circuit may include: a first boosting transistor connected between the boosting clock input terminal and the voltage control line, the first boosting transistor including a gate electrode connected to the first node; a second boosting transistor connected between the voltage control line and the second power input terminal, the second boosting transistor including a gate electrode connected to the second node; and a first capacitor connected between the first node and the voltage control line.

The control circuit may include: a first control circuit connected to the first power input terminal and the connection control line, the first control circuit controlling an electrical connection between the first power input terminal and the connection control line, based on a first carry signal input to a first carry input terminal and a second carry signal input to a second carry input terminal; and a second control circuit connected to the third power input terminal and the connection control line, the second control circuit controlling an electrical connection between the third power input terminal and the connection control line, based on a third carry signal input to a third carry input terminal.

The third power source may have a voltage which is higher than the voltage of the second power source and is lower than the voltage of the first power source.

The first carry signal may be a carry signal of a previous stage circuit, and the second carry signal and the third carry signal may be carry signals of next stage circuits.

In case that the stage circuit is an ith (i is a natural number of 1 or more) stage circuit, the first carry signal may be an (i−1)th carry signal, the second carry signal may be an (i+1)th carry signal, and the third carry signal may be an (i+2)th carry signal.

The first control circuit may include: a first control transistor connected between the first power input terminal and the connection control line; and a second control transistor connected between the first power input terminal and the connection control line, the second control transistor including a gate electrode connected to the second carry input terminal.

A gate electrode of the first control transistor may be connected to the first carry input terminal.

A gate electrode of the first control transistor may be connected to the first node.

The first control circuit may further include a third control transistor connected between the first power input terminal and the connection control line, the third control transistor including a gate electrode connected to a first reset input terminal to which a first reset signal is input.

At least one of the first control transistor, the second control transistor, or a third control transistor may be configured such that a plurality of transistors are connected in series to each other.

The second control circuit may include a first switching transistor connected between the connection control line and the third power input terminal, the first switching transistor including a gate electrode connected to the third carry input terminal.

The second control circuit may further include a second switching transistor connected between the connection control line and the third power input terminal, the second switching transistor including a gate electrode connected to the voltage control line.

The third power source and the second power source may be set to a same voltage.

In accordance with another aspect of the disclosure, there is provided a display device including: pixels located to be connected to scan lines and data lines; and a scan driver including stage circuits to drive the scan lines, wherein at least one stage circuit among the stage circuits includes: a driving circuit controlling a voltage of each of a first node and a second node; first output circuits receiving any one of a plurality of scan clock signals, the first output circuits outputting any one of the scan clock signals as an enable scan signal, based on a voltage of any one of local nodes; and connection circuits connected between the respective local nodes and the first node, the connection circuits controlling electrical connection between the first node and the local nodes, and wherein the connection circuits electrically interrupt the local nodes and the first node from each other during a period in which at least one of the scan clock signals is output in each of the first output circuits.

In accordance with still another aspect of the disclosure, there is provided an electronic device including: a processor; and a display device including pixels connected to scan lines and data lines and a scan driver configured to drive the scan lines, wherein at least one stage circuit among stage circuits included in the scan driver includes: a driving circuit controlling a voltage of each of a first node and a second node; first output circuits receiving any one of a plurality of scan clock signals, the first output circuits outputting any one of the scan clock signals as an enable scan signal, based on a voltage of any one of local nodes; and connection circuits connected between the respective local nodes and the first node, the connection circuits controlling electrical connection between the first node and the local nodes, and wherein the connection circuits electrically interrupt the local nodes and the first node from each other during a period in which at least one of the scan clock signals is output in each of the first output circuits.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that, in case that an element is referred to as being “between” two elements, it can be the only element between the two elements, or one or more intervening elements may also be present. Like reference numerals refer to like elements throughout.

FIG. 1 is a diagram illustrating a display device according to some embodiments of the disclosure.

FIG. 2 is a circuit diagram illustrating aspects of a pixel shown in FIG. 1.

FIG. 3 is a diagram illustrating aspects of a scan driver shown in FIG. 1.

FIG. 4 is a block diagram illustrating a stage circuit shown in FIG. 3.

FIG. 5 is a diagram illustrating aspects of a circuit corresponding to each of blocks shown in FIG. 4.

FIG. 6 is a waveform diagram illustrating aspects of a method of driving a stage circuit shown in FIG. 5.

FIG. 7 is a diagram illustrating aspects of a circuit corresponding to each of the blocks shown in FIG. 4.

FIG. 8 is a diagram illustrating aspects of a circuit corresponding to each of the blocks shown in FIG. 4.

FIG. 9 is a diagram illustrating aspects of a circuit corresponding to each of the blocks shown in FIG. 4.

FIG. 10 is a waveform diagram illustrating aspects of a method of driving a stage circuit shown in FIG. 9.

FIG. 11 is a diagram illustrating aspects of a circuit corresponding to each of the blocks shown in FIG. 4.

FIG. 12 is a diagram illustrating aspects of a driving circuit shown in FIG. 4.

FIG. 13 is a waveform diagram illustrating aspects an operation process of the driving circuit shown in FIG. 12.

FIG. 14 is a block diagram illustrating aspects of an electronic device including the display device shown in FIG. 1.

FIG. 15 is a perspective view illustrating an example of a smartphone capable of being implemented using the electronic device shown in FIG. 14.

FIG. 16 is a perspective view illustrating an example of a tablet computer capable of being implemented using the electronic device shown in FIG. 14.

### DETAILED DESCRIPTION

Hereinafter, example embodiments are described in detail with reference to the accompanying drawings so that those skilled in the art may easily practice the disclosure. The disclosure may be implemented in various different forms and is not limited to the example embodiments described in the specification.

A part irrelevant to the description may be omitted to clearly describe the disclosure, and the same or similar constituent elements will be designated by the same reference numerals throughout the specification. Therefore, the same reference numerals may be used in different drawings to identify the same or similar elements.

In description, the expression “equal” may mean “substantially equal.” That is, this may mean equality to a degree to which those skilled in the art can understand the equality. Other expressions may be expressions in which “substantially” is omitted.

Some embodiments are described in the accompanying drawings in relation to functional blocks, units, and/or modules. Those skilled in the art will understand that these blocks, units, and/or modules are physically implemented by logic circuits, individual components, microprocessors, hard wire circuits, memory elements, line connection, and other electronic circuits. This may be formed by using semiconductor-based manufacturing techniques or other manufacturing techniques. In the case of blocks, units, and/or modules implemented by microprocessors or other similar hardware, the units, and/or modules are programmed and controlled by using software, to perform various functions discussed in the disclosure, and may be selectively driven by firmware and/or software. In addition, each block, each unit, and/or each module may be implemented by dedicated hardware or by a combination dedicated hardware to perform some functions of the block, the unit, and/or the module and a processor (e.g., one or more programmed microprocessors and associated circuitry) to perform other functions of the block, the unit, and/or the module. In some embodiments, the blocks, the units, and/or the modules may be physically separated into two or more individual blocks, two or more individual units, and/or two or more individual modules without departing from the scope of the disclosure. Also, in some embodiments, the blocks, the units, and/or the modules may be physically separated into more complex blocks, more complex units, and/or more complex modules without departing from the scope of the disclosure.

The term “connection” between two components may include both electrical connection and physical connection, but the disclosure is not necessarily limited thereto. For example, the term “connection” used based on circuit diagrams may mean electrical connection, and the term “connection” used based on sectional and plan views may mean physical connection.

It will be understood that, although the terms “first,” “second,” etc. may be used herein to describe various elements, these elements should not be limited by these terms. These terms are only used to distinguish one element from another element. Thus, a “first” element discussed below could also be termed a “second” element without departing from the teachings of the disclosure.

The disclosure is not limited to embodiments disclosed below, and may be implemented in various forms. Each embodiment disclosed below may be independently embodied or be combined with at least another embodiment prior to being embodied.

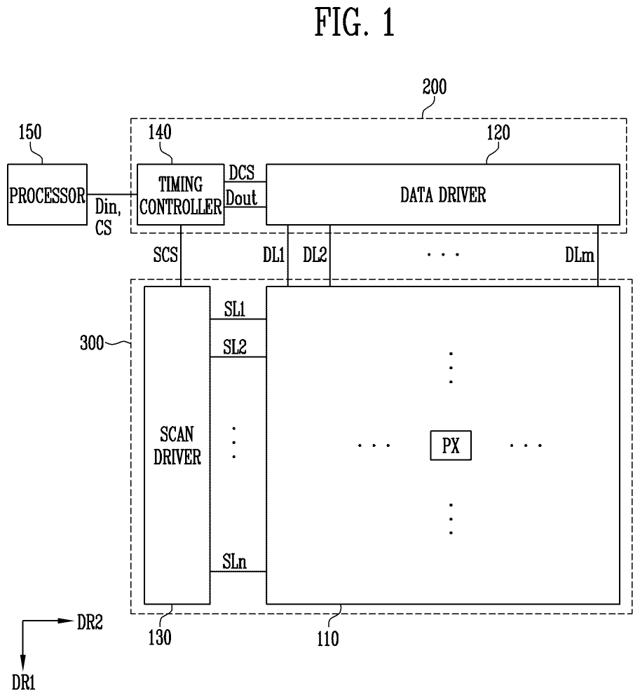

FIG. 1 is a diagram illustrating a display device according to some embodiments of the present disclosure.

Referring to FIG. 1, a display device according to some embodiments of the present disclosure may include a display driver 200 and a display unit 300.

The display driver 200 may control the display unit 300. To this end, the display driver 200 may include a timing controller 140 and a data driver 120. The display driver 200 may include a single IC or include a plurality of ICs. The display unit 300 may display an image. To this end, the display unit 300 may include a pixel unit 110, and a scan driver 130.

The timing controller 140 may receive, from a processor 150, input data Din corresponding to respective frames and control signals CS. The processor 150 may correspond to a Graphics Processing Unit (GPU), a Central Processing Unit (CPU), an Application Processor (AP), or the like. The control signals CS may include various signals necessary for driving of the display device. The input data Din may correspond to an image displayed in the pixel unit 110.

The timing controller 140 may realign the input data Din to be suitable for specifications of the display device. Also, the timing controller 140 may generate output data Dout by correcting the input data Din, and supply the output data Dout to the data driver 120. According to some embodiments, the timing controller 140 may generate the output data Dout by correcting the input data Din, based on an optical measurement result.

According to some embodiments, the timing controller 140 may generate a data driving signal DCS and a scan driving signal SCS, corresponding to the control signal CS. The data driving signal DCS may be supplied to the data driver 120, and the scan driving signal SCS may be supplied to the scan driver 130.

The pixel unit 110 may include pixels PX located to be connected to scan lines SL1, SL2, . . . , and SLn (n is a natural number of 3 or more) and data lines DL1, DL2, . . . , and DLm (m is a natural number of 3 or more).

The data lines DL1 to DLm may be arranged to extend in a first direction DR1. The first direction DR1 may be, for example, a direction in which an upper side and a lower side of the pixel unit 110 are connected to each other. In another example, the first direction DR1 may be a direction in which a left side and a right side of the pixel unit 110 are connected to each other, and be designated as a direction different from the direction.

The scan lines SL1 to SLn may be arranged to extend in a second direction DR2. The second direction DR2 may be, for example, a direction orthogonal to the first direction DR1. The second direction DR2 may be a direction in which the left side and the right side of the pixel unit 110 are connected to each other. In another example, the second direction DR2 may be a direction in which the upper side and the lower side of the pixel unit 110 are connected to each other, and be designated as a direction different from the direction.

A plurality of pixels PX may be arranged in the pixel unit 110 to be electrically connected to the data lines DL1 to DLm and the scan lines SL1 to SLn. The pixels PX may be sub-pixels. According to some embodiments, the pixels PX may be arranged in various manners currently known in the art.

Pixels PX may be selected in a unit of a horizontal line (e.g., pixels PX connected to a same scan line are sorted as a horizontal line (or pixel row)) in case that a scan signal is supplied to the scan lines SL1 to SLn. The pixels PX selected by the scan signal may be supplied with a data signal from a data line (any one of DL1 to DLm) connected thereto. The pixels PX supplied with the data signal may generate light with a luminance corresponding to a voltage of the data signal.

The data driver 120 may receive the output data Dout and the data driving signal DCS from the timing controller 140. The data driver 120 may generate a data signal, based on the data driving signal DCS and the output data Dout. According to some embodiments, the data driver 120 may generate an analog data signal, based on a grayscale of the output data Dout. The data driver 120 may supply a data signal in a unit of a horizontal period.

The scan driver 130 may receive the scan driving signal SCS from the timing controller 140.

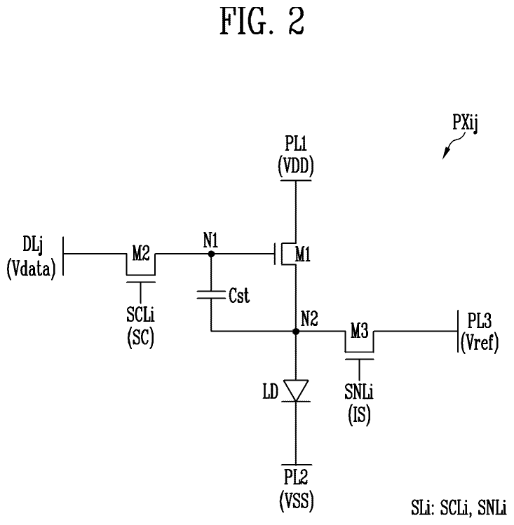

According to some embodiments, each of the scan lines SL1 to SLn may include a scan line SCL and an initialization line SNL as shown in FIG. 2. The scan driver 130 may sequentially supply a first scan signal to scan lines SCL, corresponding to the scan driving signal SCS. The scan driver 130 may sequentially supply a second scan signal to initialization lines SNL, corresponding to the scan driving signal SCS. To this end, the scan driver 130 may include a first scan driver for driving the scan lines SCL and a second scan driver for driving the initialization lines SNL. The first scan driver and the second scan driver may be formed into a single scan driver 130 as shown in FIG. 1, and be formed as drivers separate from each other. According to some embodiments, the first scan driver and the second scan driver may be arranged to be spaced apart from each other while the pixel unit 110 is interposed between the first scan driver and the second scan driver.

According to some embodiments of the present disclosure, the display device may include a flat panel display device, a curved display device in which a portion of the pixel unit 110 is curved, a flexible display device in which a portion of the pixel unit 110 is folded or bent, and a stretchable display device in which a portion of the pixel unit 110 is expanded/contracted.

According to some embodiments of the present disclosure, the display device is a device which displays moving images or still images, and may include portable electronic devices such as a mobile phone, a smartphone, a tablet personal computer (PC), a smart watch, a watch phone, a portable multimedia player (PMP), a navigation system, and an ultra mobile computer (UMPC). According to some embodiments of the present disclosure, the display device may include electronic devices such as a television, a notebook computer, a monitor, an advertisement board, and Internet of things (IOT).

FIG. 2 is a circuit diagram illustrating aspects of the pixel shown in FIG. 1. For convenience of description, a pixel PXij located on an ith (i is a natural number of n or less and 1 or more) horizontal line and a jth (j is a natural number of m or less and 1 or more) vertical line is illustrated in FIG. 2. Although FIG. 2 illustrates various components in a pixel according to some embodiments, embodiments according to the present disclosure are not limited thereto, and according to various embodiments, the pixel may include additional components, or fewer components, without departing from the spirit and scope of embodiments according to the present disclosure.

Referring to FIG. 2, a pixel PXij according to some embodiments of the present disclosure may include a light emitting element LD and a pixel circuit for controlling an amount of current supplied to the light emitting element LD. An ith scan line SLi may include an ith scan line SCLi and an ith initialization line SNLi.

A first electrode (or anode electrode) of the light emitting element LD may be connected to a first power line PL1 via a second node N2 and a first transistor M1, and a second electrode (or cathode electrode) of the light emitting element LD may be connected to a second power line PL2. The light emitting element LD may generate light with a luminance corresponding to an amount of current supplied from the first transistor M1.

A first driving power source VDD may be supplied to the first power line PL1, and a second driving power source VSS may be supplied to the second power line PL2. During a period in which the pixel PXij emits light, the first driving power source VDD may have a relatively high voltage value as compared with the second driving power source VSS.

The light emitting element LD may be selected as an organic light emitting diode. Also, the light emitting element LD may be selected as an inorganic light emitting diode such as a micro LED (light emitting diode) or a quantum dot light emitting diode. Also, the light emitting element LD may be an element configured with a combination of an organic material and an inorganic material. In FIG. 2, it is illustrated that the pixel PXij includes a single light emitting element LD. However, according to some embodiments, the pixel PXij may include a plurality of light emitting elements LD, and the plurality of light emitting elements LD may be connected in series, parallel or series/parallel to each other.

The pixel circuit may include the first transistor M1, a second transistor M2, a third transistor M3, and a storage capacitor Cst.

A first electrode of the first transistor M1 may be connected to the first power line PL1, and a second electrode of the first transistor M1 may be connected to the second node N2. The term “being connected” may include a meaning of “being electrically connected.” A gate electrode of the first transistor M1 may be connected to a first node N1. The first transistor M1 may control an amount of current supplied from the first power line PL1 to the second power line PL2 via the light emitting element LD, corresponding to a voltage of the first node N1.

The second transistor M2 may be connected to a jth data line DLj and the first node N1. In addition, a gate electrode of the second transistor M2 may be electrically connected to the ith scan line SCLi. The second transistor M2 may be turned on in case that an enable first scan signal SC is supplied to the ith scan line SCLi, to electrically connect the jth data line DLj and the first node N1. In case that the second transistor M2 is turned on, a data signal Vdata from the jth data line DLj may be supplied to the first node N1.

A first scan signal SC may have a gate-on voltage (e.g., enable) or a gate-off voltage (e.g., disable). An enable first scan signal SC may mean that the gate-on voltage is supplied to a scan line SCL, and a disable first scan signal SC may mean that the gate-off voltage is supplied to the scan line SCL.

The third transistor M3 may be connected between the second node N2 and a third power line PL3. In addition, a gate electrode of the third transistor M3 may be electrically connected to the ith initialization line SNLi. The third transistor M3 may be turned on in case that an enable second scan signal IS is supplied to the ith initialization line SNLi, to electrically connect the second node N2 and the third power line PL3 to each other. In case that the third transistor M3 is turned on, a voltage of a reference power source Vref from the third power line PL3 may be supplied to the second node N2.

The reference power source Vref may be supplied to the third power line PL3. The voltage of the reference power source Vref may be set such that the light emitting element LD is turned off in case that the voltage of the reference power source Vref is supplied to the second node N2. To this end, a difference in voltage between the reference power source Vref and the second driving power source VSS may be lower than a threshold voltage of the light emitting element LD. According to some embodiments, the voltage of the reference power source Vref may be set as a voltage equal or similar to a voltage of the second driving power source VSS.

A second scan signal IS may have a gate-on voltage (e.g., enable) or a gate-off voltage (e.g., disable). An enable second scan signal IS may mean that the gate-on voltage is supplied to an initialization line SNL, and a disable second scan signal IS may mean that the gate-off voltage is supplied to the initialization line SNL.

In FIG. 2, it is illustrated that the first transistor M1 to the third transistor M3 are implemented with an N-type transistor. However, the embodiments of the present disclosure are not limited thereto. According to some embodiments, at least one transistor among the first transistor M1 to the third transistor M3 may be implemented with a P-type transistor.

The storage capacitor Cst may be connected between the first node N1 and the second node N2. The storage capacitor Cst may store a voltage corresponding to the data signal Vdata. According to some embodiments, the storage capacitor Cst may store a voltage corresponding to a difference between the data signal Vdata supplied to the first node N1 and the reference power source Vref supplied to the second node N2.

Additionally, the structure of the pixel PXij is not limited to the embodiments shown in FIG. 2. According to some embodiments, the pixel PXij may be implemented with various types of circuits currently known in the art.

An operation process will be briefly described. During a driving period, an enable first scan signal SC and an enable second scan signal IS in synchronization with the enable first scan signal SC may be supplied to be synchronized with the enable first scan signal SC. The enable first scan signal SC supplied to the ith scan line SCLi may be supplied to be synchronized with the enable second scan signal IS supplied to the ith initialization line SNLi.

In case that the enable second scan signal IS is supplied, the third transistor M3 may be turned on, and the voltage of the reference power source Vref may be supplied to the second node N2. In case that the enable first scan signal SC is supplied, the second transistor M2 may be turned on, a data signal Vdata may be supplied to the first node N1. A voltage corresponding to a difference between the data signal Vdata and the reference power source Vref.

After that, the second transistor M2 may be turned off by a disable first scan signal SC, and the third transistor M3 may be turned off by a disable second scan signal IS. The first transistor M1 may supply, to the light emitting element LD, a driving current corresponding to a voltage stored in the storage capacitor Cst, and the light emitting element LD may generate light with a luminance corresponding to the driving current.

During a sensing period, an enable first scan signal SC and an enable second scan signal IS in synchronization with the enable first scan signal SC may be supplied to at least one scan among the scan lines SL1 to SLn. A scan line (at least one of SL1 to SLn) to which the enable first scan signal SC and the enable second scan signal IS are supplied in the sensing period may be randomly set for each sensing period.

According to some embodiments, during the sensing period, the enable second scan signal IS may be supplied to the ith initialization line SNLi, and the enable first scan signal SC may be supplied to the ith scan line SCLi. In case that the enable second scan signal IS is supplied to the ith initialization line SNLi, the third transistor M3 may be turned on, and the voltage of the reference power source Vref may be supplied to the second node N2.

In case that the enable first scan signal SC is supplied to the ith scan line SCLi, the second transistor M2 may be turned on, and a reference data signal may be supplied to the first node N1. The reference data signal may have a voltage (e.g., a set or predetermined voltage) such that a characteristic of the pixels PX can be sensed. A voltage corresponding to a difference between the reference data signal and the reference power source Vref may be stored in the storage capacitor Cst.

After that, the second transistor M2 may be turned off by a disable first scan signal SC supplied to the ith scan line SCLi. A tun-on state of the third transistor M3 may be maintained, and the third power line PL3 may be electrically connected to the timing controller 140 (the voltage of the reference power source Vref is not supplied to the third power line PL3).

A current supplied corresponding to the reference data signal from the first transistor M1 may be supplied to the timing controller 140 via the second node N2 and the third transistor M3, and the timing controller 140 may control output data Dout such that a threshold voltage of the first transistor M1, a mobility of the first transistor M1, and/or degradation of the light emitting element LD can be compensated corresponding to a current (or voltage) from the second node N2.

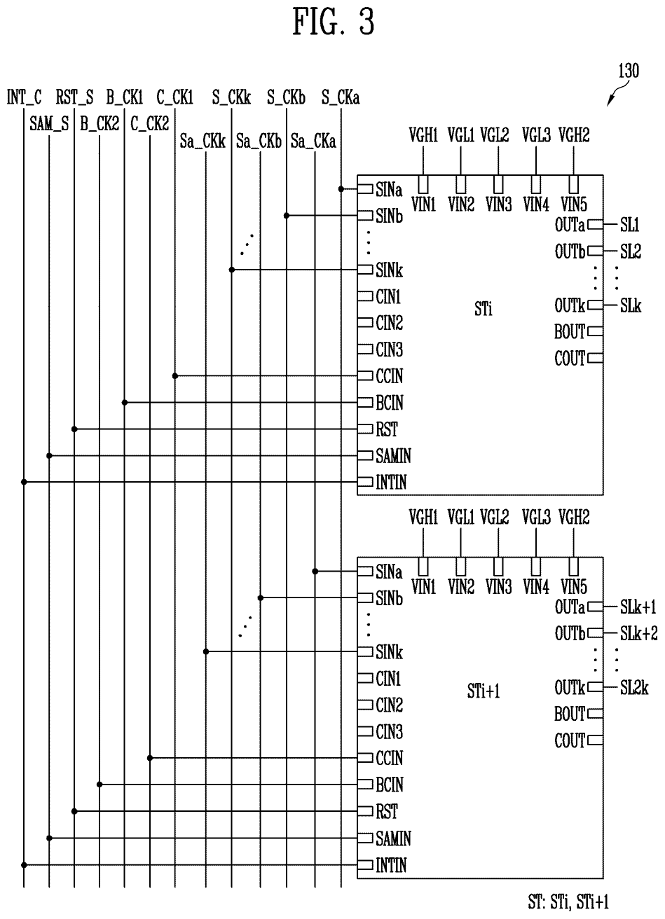

FIG. 3 is a diagram illustrating aspects of the scan driver shown in FIG. 1. For convenience of description, an ith stage circuit STi and an (i+1)th stage circuit STi+1 will be described in FIG. 3.

Referring to FIG. 3, a scan driver 130 according to some embodiments of the present disclosure may include a plurality of stage circuits ST. Each of stage circuits STi and STi+1 may be connected to a plurality of scan lines SL1, SL2, . . . , and SLk or SLK+1, SLk+2, . . . , and SL2k (k is a natural number of 2 or more). Each of the scan lines SL1 to SLk or SLk+1 to SL2k may include at least one of the scan line SCL or the initialization line SNL, shown in FIG. 2.

According to some embodiments, in case that the scan driver 130 is a first scan driver, each of the scan lines SL1 to SLk or SLk+1 to SL2k may be the scan line SCL. According to some embodiments, in case that the scan driver 130 is a second scan driver, each of the scan lines SL1 to SLk or SLk+1 to SL2k may be the initialization line SNL. According to some embodiments, in case that the scan driver 130 includes the first scan driver and the second scan driver, each of the scan lines SL1 to SLk or SLk+1 to SL2k may include at least one of the scan line SCL or the initialization line SNL.

An ith stage circuit STi may be connected to k scan lines SL1 to SLk, and supply a scan signal to the k scan lines SL1 to SLk. An (i+1)th stage circuit STi+1 may be connected to k scan lines SLk+1 to SL2k, and supply a scan signal to the k scan lines SLk+1 to SL2k. For example, according to some embodiments of the present disclosure, a scan signal may be supplied to a plurality of scan lines, using a single stage circuit, and accordingly, the mounting area of the scan driver 130 can be minimized or reduce.

Each of the stage circuits STi and STi+1 may include power input terminals VIN1, VIN2, VIN3, VIN4, and VIN5, scan clock input terminals SINa, SINb, . . . , and SINK, carry input terminals CIN1, CIN2, and CIN, a carry clock input terminal CCIN, a boosting clock input terminal BCIN, a carry output terminal COUT, and a boosting output terminal BOUT. Each of the stage circuits STi and STi+1 may include a reset input terminal RST, a sampling input terminal SAMIN, and an initialization terminal INTIN. According to some embodiments, a configuration of input terminals and output terminals of each of the stage circuits STi and STi+1 may be variously set corresponding to a configuration of the stage circuits STi and STi+1.

A first power input terminal VIN1 may receive a voltage of a first power source VGH1. The first power source VGH1 may have a logic high level voltage.

A second power input terminal VIN2 may receive a voltage of a second power source VGL1. The second power source VGL1 may have a logic low level voltage. According to some embodiments, the second power source VGL1 may have a voltage lower than the voltage of the first power source VGH1.

A third power input terminal VIN3 may receive a voltage of a third power source VGL2. The third power source VGL2 may have a logic low level voltage. According to some embodiments, the third power source VGL2 may have a voltage which is higher than the voltage of the second power source VGL1 and is lower than the voltage of the first power source VGH1.

A fourth power input terminal VIN4 may receive a voltage of a fourth power source VGL3. The fourth power source VGL3 may have a logic low level voltage. According to some embodiments, the fourth power source VGL3 may have a voltage which is higher than the voltage of the second power source VGL1 and is lower than the voltage of the third power source VGL2.

A fifth power input terminal VIN5 may receive a voltage of a fifth power source VGH2. The fifth power source VGH2 may have a logic high level voltage. According to some embodiments, the fifth power source VGH2 may have a voltage lower than the voltage of the first power source VGH1.

Each of output terminals OUTa, OUTb, . . . , and OUTk may be connected to a scan line (any one of SL1 to SLk or any one of SLk+1 to SL2k). Each of the output terminals OUTa, OUTb, . . . , and OUTk may output a scan signal to a scan line (any one of SL1 to SLk or any one of SLk+1 to SL2k) connected thereto.

Each of scan clock input terminals SINa, SINb, . . . , and SINk included in an odd-numbered stage circuit (e.g., STi) may receive any one of scan clock signals S_CKa, S_CKb, . . . , and S_CKk. The scan clock signals S_CKa to S_CKk may be supplied to any one of output terminals OUTa to OUTk, and the scan clock signals S_CKa to S_CKk supplied to the output terminals OUTa to OUTk may be supplied as enable scan signals to the scan lines SL1 to SLk.

Each of scan clock input terminals SINa, SINb, . . . , and SINk included in an even-numbered stage circuit (e.g., STi+1) may receive any one of scan clock signals Sa_CKa, Sa_CKb, . . . , and Sa_CKk. The scan clock signals Sa_CKa to Sa_CKk may be supplied to any one of output terminals OUTa to OUTk, and the scan clock signals Sa_CKa to Sa_CKk supplied to the output terminals OUTa to OUTk may be supplied as enable scan signals to the scan lines SLk+1 to SL2k.

In FIG. 3, it is illustrated that the scan clock signals S_CKa to S_CKk supplied to the odd-numbered stage circuit (e.g., STi) and the scan clock signals Sa_CKa to Sa_CKk supplied to the even-numbered stage circuit (e.g., STi+1) are different signals. However, the disclosure is not limited thereto. According to some embodiments, at least one of the scan clock signals supplied to the odd-numbered stage circuit (e.g., STi) or the even-numbered stage circuit (e.g., STi+1) may be shared.

Carry input terminals CIN1, CIN2, and CIN3 may receive a carry signal from a previous stage circuit and/or a next stage circuit. According to some embodiments, a first carry input terminal CIN1 included in the ith stage circuit STi may receive a (i−1)th carry signal (e.g., a first carry signal), a second carry input terminal CIN2 included in the ith stage circuit STi may receive a (i+1)th carry signal (e.g., a second carry signal), and a third carry input terminal CIN3 included in the ith stage circuit STi may receive a (i+2)th carry signal (e.g., a third carry signal).

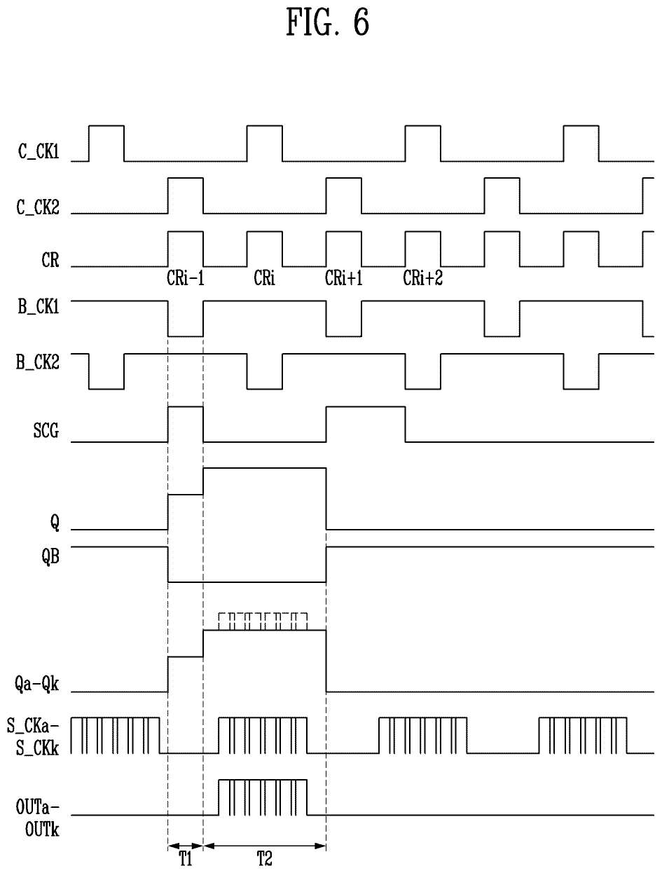

A carry clock input terminal CCIN included in the odd-numbered stage circuit (e.g., STi) may receive a first carry clock signal C_CK1, and a carry clock input terminal CCIN included in the even-numbered stage circuit (e.g., STi+1) may receive a second carry clock signal C_CK2. The first carry clock signal C_CK1 and the second carry clock signal C_CK2 may have a same cycle and have different phases as shown in FIG. 6. According to some embodiments, the first carry clock signal C_CK1 and the second carry clock signal C_CK2 may have a phase difference of 180 degrees.

A boosting clock input terminal BCIN included in the odd-numbered stage circuit (e.g., STi) may receive a first boosting clock signal B_CK1, and a boosting clock input terminal BCIN included in the even-numbered stage circuit (e.g., STi+1) may receive a second boosting clock signal B_CK2. The first boosting clock signal B_CK1 and the second boosting clock signal B_CK2 may have a same cycle and have different phases as shown in FIG. 6. According to some embodiments, the first boosting clock signal B_CK1 and the second boosting clock signal B_CK2 may have a phase difference of 180 degrees.

A carry output terminal COUT may output a carry signal. A carry output terminal COUT included in the ith state circuit STi may output an ith carry signal. A carry output terminal COUT included in the (i+1)th stage circuit STi+1 may output an (i+1)th carry signal.

A boosting output terminal BOUT may output a boosting signal. A boosting output terminal BOUT included in the ith stage circuit STi may output an ith boosting signal. A boosting output terminal BOUT included in the (i+1)th stage circuit STi+1 may output an (i+1)th boosting signal.

A reset input terminal RST may receive a reset signal RST_S. The reset signal RST_S may be commonly supplied to all stage circuits, and be used to reset the stage circuits.

A sampling input terminal SAMIN may receive a sampling signal SAM_S. The sampling signal SAM_S may be supplied during a driving period, and be a signal for selecting a stage circuit (or a scan line and an initialization line) in which a first scan signal SC and a second scan signal IS are to be supplied during a sensing period.

An initialization terminal INTIN may receive an initialization control signal INT_C. The initialization control signal INT_C may be supplied during the sensing period, and be a signal for enabling the first scan signal SC and the second scan signal IS to be supplied in the stage circuit selected by the sampling signal SAM_S.

The sampling signal SAM_S and the initialization control signal INT_C may be global signals commonly supplied to all the stage circuits. In case that the sampling signal SAM_S or the initialization control signal INT_C is supplied, all the stage circuits may receive the sampling signal SAM_S or the initialization control signal INT_C.

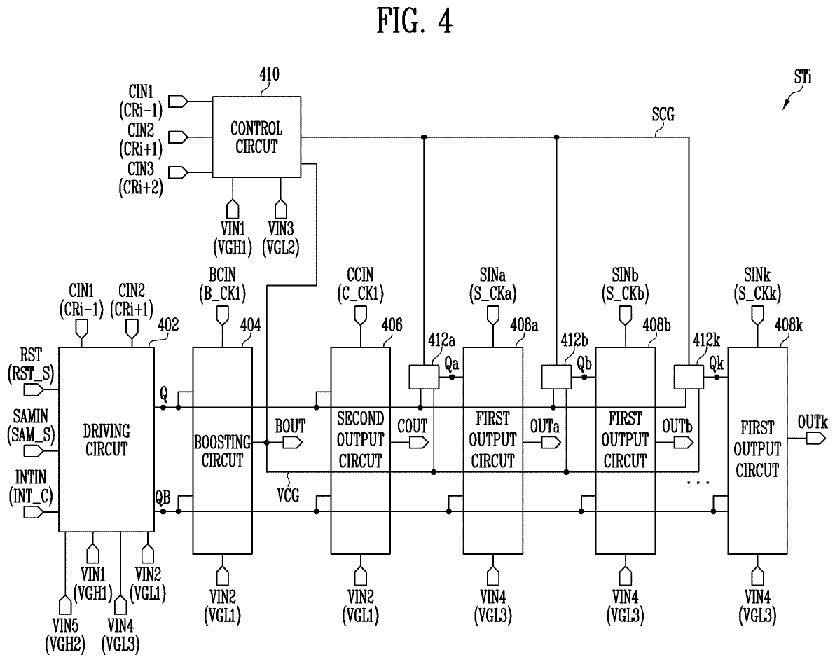

FIG. 4 is a block diagram illustrating the stage circuit shown in FIG. 3. For convenience of description, the ith stage circuit STi will be illustrated in FIG. 4. The (i+1)th stage circuit STi+1 may also be configured identically (or substantially identically) to the ith stage circuit STi.

Referring to FIG. 4, the stage circuit STi according to some embodiments of the present disclosure may include a driving circuit 402, a boosting circuit 404, first output circuits 408a, 408b, . . . , and 408k, a second output circuit 406, connection circuits 412a, 412b, . . . , and 412k, and a control circuit 410.

The driving circuit 402 may be connected to a first power input terminal VIN1, a second power input terminal VIN2, a fourth power input terminal VIN4, a fifth power input terminal VIN5, a reset input terminal RST, a sampling input terminal SAMIN, an initialization terminal INTIN, a first carry input terminal CIN1, and a second carry input terminal CIN2. The driving circuit 402 may control a voltage of each of a first node Q and a second node QB. A configuration of the driving circuit 402 will be described in detail later.

The second output circuit 406 may be connected to a carry clock input terminal CCIN, the second power input terminal VIN2, and a carry output terminal COUT. The second output circuit 406 may output a carry signal to the carry output terminal COUT, corresponding to the voltage of each of the first node Q and the second node QB.

The boosting circuit 404 may be connected to a boosting clock input terminal BCIN, the second power input terminal VIN2, and a boosting output terminal BOUT. The boosting circuit 404 may output a boosting signal to the boosting output terminal BOUT, corresponding to the voltage of each of the first node Q and the second node QB. The boosting output terminal BOUT may be electrically connected to a voltage control line VCG. The voltage control line VCG may be electrically connected to the connection circuits 412a, 412b, . . . , and 412k.

Each of the first output circuits 408a, 408b, . . . , and 408k may be connected to any one of scan clock input terminals SINa, SINb, . . . , and SINk, any one of output terminals OUTa, OUTb, . . . , and OUTk, and the fourth power input terminal VIN4. Each of the first output circuits 408a, 408b, . . . , and 408k may be connected to the first node Q via any one of local nodes Qa, Qb, . . . , and Qk and any one of the connection circuits 412a, 412b, . . . , and 412k. The first output circuits 408a, 408b, . . . , and 408k may supply a scan signal to the output terminals OUTa, OUTb, . . . , and OUTk, based on a voltage of each of the local nodes Qa, Qb, . . . , and Qk.

The connection circuits 412a, 412b, . . . , and 412k may be connected between the first node Q and the local nodes Qa, Qb, . . . , and Qk, respectively. Each of the connection circuits 412a, 412b, . . . , and 412k may electrically connect the first node Q and any one of the local nodes Qa, Qb, . . . , and Qk to each other during a first period T1 (see FIG. 6) in a period in which the first node Q has a first level (e.g., a high level voltage), and electrically interrupt the first node Q and any one of the local nodes Qa, Qb, . . . , and Qk from each other during a second period T2 (see FIG. 6) after the first period T1 in the period in which the first node Q has the first level.

The second period T2 may be a period in which an enable scan signal is output from the first output circuits 408a, 408b, . . . , and 408k. Each of the connection circuits 412a, 412b, . . . , and 412k may electrically interrupt the first node Q and any one of the local nodes Qa, Qb, . . . , and Qk from each other during the period in which the enable scan signal is output from the first output circuits 408a, 408b, . . . , and 408k, and accordingly, a luminance deviation in a unit of a horizontal line can be prevented or reduced.

In case that the first node Q and the local nodes Qa, Qb, . . . , and Qk are electrically connected to each other during the second period T2 in which the enable scan signal is output from the first output circuits 408a, 408b, . . . , and 408k, a voltage of the first node Q may be changed when scan signals are output from the first output circuits 408a, 408b, . . . , and 408k. For example, the voltage of the first node Q may be changed corresponding to a supply order of the scan signals, whether the scan signals overlap with each other, or the like.

In case that the voltage of the first node Q is changed, a voltage of each of the local nodes Qa, Qb, . . . , and Qk may be changed. In case that the voltage of each of the local nodes Qa, Qb, . . . , and Qk is changed during the second period T2, scan signals having different voltages may be output from the first output circuits 408a, 408b, . . . , and 408k, and accordingly, a luminance difference in a unit of a horizontal line may occur.

According to some embodiments of the present disclosure, the first output circuits 408a, 408b, . . . , and 408k and the first node Q may be electrically interrupted from each other during the second period T2 in which a scan signal is output using the connection circuits 412a, 412b, . . . , and 412k.

According to some embodiments, a voltage of a local node Qa may be changed in case that a scan signal is output from a first output circuit 408a, a voltage of a local node Qb may be changed in case that a scan signal is output from a first output circuit 408b, and a voltage of a local node Qk may be changed in case that a scan signal is output from a first output circuit 408k. Voltage variations of the local nodes Qa, Qb, . . . , and Qk may be the same (or substantially the same), and accordingly, the first output circuits 408a, 408b, . . . , and 408k may output a scan signal having a same (or substantially the same) voltage.

According to some embodiments of the present disclosure, the voltage of the first node Q is not changed by the voltage of each of the local nodes Qa, Qb, . . . , and Qk during the second period T2. In addition, although the voltage of the first node Q1 is changed during the second period T2, this has no influence on the voltage of each of the local nodes Qa, Qb, . . . , and Qk. Thus, according to some embodiments of the present disclosure, the luminance deviation in the unit of the horizontal line can be prevented or reduced.

The control circuit 410 may be connected to the connection circuits 412a, 412b, . . . , and 412k via a connection control line SCG. The control circuit 410 may be connected to the first carry input terminal CIN1, the second carry input terminal CIN2, a third carry input terminal CIN3, the first power input terminal VIN1, and a third power input terminal VIN3. The control circuit 410 may control a voltage of the connection control line SCG, corresponding to a carry signal input to each of the first carry input terminal CIN1, the second carry input terminal CIN2, and the third carry input terminal CIN3.

The connection circuits 412a, 412b, . . . , and 412k may control electrical connections between the local nodes Qa, Qb, . . . , and Qk and the first node Q, corresponding to the voltage of the connection control line SCG. According to some embodiments, the connection circuits 412a, 412b, . . . , and 412k may electrically connect the local nodes Qa, Qb, . . . , Qk and the first node Q to each other in case that the connection control line SCG has a logic high level, and electrically interrupt the local nodes Qa, Qb, . . . , Qk and the first node Q from each other in case that the connection control line SCG has a logic low level.

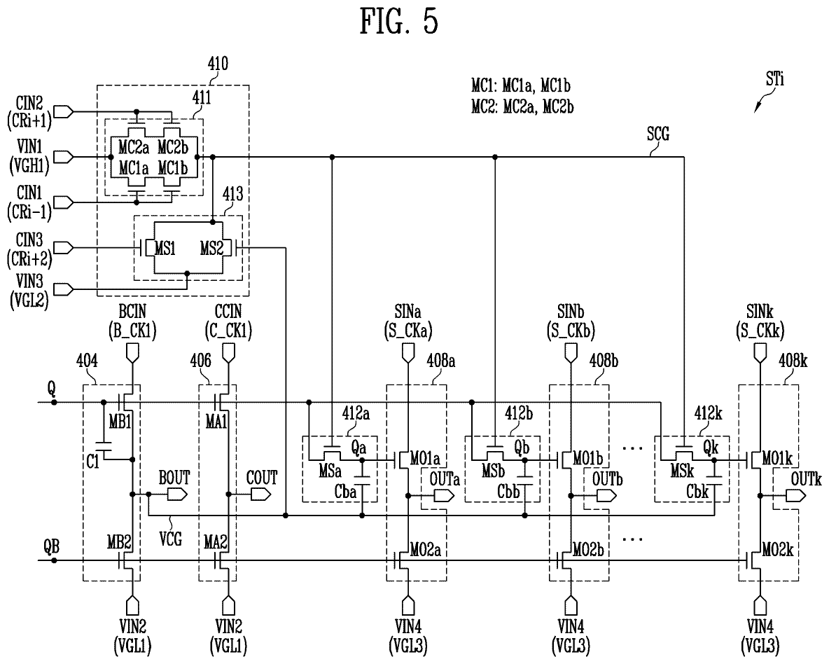

FIG. 5 is a diagram illustrating aspects of a circuit corresponding to each of blocks shown in FIG. 4. The driving circuit 402 may be implemented in various forms currently known in the art.

Referring to FIG. 5, the boosting circuit 404 may electrically connect the voltage control line VCG (and the boosting output terminal BOUT) to the boosting clock input terminal BCIN or the second power input terminal VIN2, corresponding to the voltage of each of the first node Q and the second node QB. It may be described that a boosting signal is output in case that the first boosting clock signal B_CK1 is supplied to the voltage control line VCG.

The boosting signal supplied to the voltage control line VCG may boost the voltage of each of the local nodes Qa, Qb, . . . , and Qk. The boosting signal supplied to the boosting output terminal BOUT may be supplied as a start signal, a carry signal, or the like to a next stage circuit. However, the boosting output terminal BOUT may be omitted corresponding to a circuit configuration of the stage circuit.

The boosting circuit 404 may include a first boosting transistor MB1, a second boosting transistor MB2, and a first capacitor C1.

The first boosting transistor MB1 may be connected between the boosting clock input terminal BCIN and the voltage control line VCG, and a gate electrode of the first boosting transistor MB1 may be connected to the first node Q1. The first boosting transistor MB1 may control an electrical connection between the boosting clock input terminal BCIN and the voltage control line VCG, corresponding to the voltage of the first node Q.

The second boosting transistor MB2 may be connected between the voltage control line VCG and the second power input terminal VIN2, and a gate electrode of the second boosting transistor M2 may be connected to the second node QB. The second boosting transistor MB2 may control an electrical connection between the voltage control line VCG and the second power input terminal VIN2, corresponding to the voltage of the second node QB.

The second output circuit 406 may electrically connect the carry output terminal COUT to the carry clock input terminal CCIN or the second power input terminal VIN2, corresponding to the voltage of each of the first node Q and the second node QB. It may be described that a carry signal (e.g., an ith carry signal) is output in case that the first carry clock signal C_CK1 is output to the carry output terminal COUT.

The second output circuit 406 may include a first carry transistor MA1 and a second carry transistor MA2.

The first carry transistor MA1 may be connected between the carry clock input terminal CCIN and the carry output terminal COUT, and a gate electrode of the first carry transistor MA1 may be connected to the first node Q. The first carry transistor MA1 may control an electrical connection between the carry clock input terminal CCIN and the carry output terminal COUT, corresponding to the voltage of the first node Q.

The second carry transistor MA2 may be connected between the carry output terminal COUT and the second power input terminal VIN2, and a gate electrode of the second carry transistor MA2 may be connected to the second node QB. The second carry transistor MA2 may control an electrical connection between the carry output terminal COUT and the second power input terminal VIN2, corresponding to the voltage of the second node QB.

Each of the first output circuits 408a, 408b, . . . , and 408k may be connected to any one of the scan clock input terminals SINa, SINb, . . . , and SINk, any one of the output terminals OUTa, OUTb, . . . , and OUTk, and the fourth power input terminal VIN4. Each of the first output circuits 408a, 408b, . . . , and 408k may include any one of first output transistors MO1a, MO1b, . . . , and MO1k and any one of second output transistors MO2a, MO2b, . . . , and MO2k.

A gate electrode of each of the first output transistors MO1a, MO1b, . . . , and MO1k may be connected to any one of the local nodes Qa, Qb, . . . , and Qk. A gate electrode of the second output transistors MO2a, MO2b, . . . , and MO2k may be electrically connected to the second node QB.

According to some embodiments, the first output circuit 408a may electrically connect the an output terminal OUTa to the scan clock input terminal SINa or the fourth power input terminal VIN4, corresponding to a voltage of the local node Qa and the voltage of the second node QB. It may be described that an enable scan signal is output in case that a scan clock signal S_CKa is supplied to the output terminal OUTa. The enable scan signal supplied to the output terminal OUTa may be supplied to a scan line (e.g., SL1) connected thereto. The first output circuit 408a may include a first output transistor MO1a and a second output transistor MO2a.

The first output transistor MO1a may be connected between the scan clock input terminal SINa and the output terminal OUTa. A gate electrode of the first output transistor MO1a may be connected to a connection circuit 412a via the local node Qa. The first output transistor MO1a may control an electrical connection between the scan clock input terminal SINa and the output terminal OUTa, corresponding to the voltage of the local node Qa.

The second output transistor MO2a may be connected between the output terminal OUTa and the fourth power input terminal VIN4, and a gate electrode of the second output transistor MO2a may be connected to the second node QB. The second output transistor MO2a may control an electrical connection between the output terminal OUTa and the fourth power input terminal VIN4, corresponding to the voltage of the second node QB.

According to some embodiments, the first output circuit 408b may electrically connect an output terminal OUTb to the scan clock input terminal SINb or the fourth power input terminal VIN4, corresponding to a voltage of the local node Qb and the voltage of the second node QB. The first output circuit 408b may include a first output transistor MO1b and a second output transistor MO2b.

The first output transistor MO1b may be connected between the scan clock input terminal SINb and the output terminal OUTb. A gate electrode of the first output transistor MO1b may be connected to a connection circuit 412b via the local node Qb. The first output transistor MO1b may control an electrical connection between the scan clock input terminal SINb and the output terminal OUTb, corresponding to the voltage of the local node Qb.

The second output transistor MO2b may be connected between the output terminal OUTb and the fourth input terminal VIN4, and a gate electrode of the second output transistor MO2b may be connected to the second node QB. The second output transistor MO2b may control an electrical connection between the output terminal OUTb and the fourth power input terminal VIN4, corresponding to the voltage of the second node QB.

According to some embodiments, the first output circuit 408k may electrically connect an output terminal OUTk to a scan clock input terminal SINk or the fourth power input terminal VIN4, corresponding to a voltage of the local node Qk and the voltage of the second node QB. The first output circuit 408k may include a first output transistor MO1k and a second output transistor MO2k.

The first output transistor MO1k may be connected between the scan clock input terminal SINK and the output terminal OUTk. A gate electrode of the first output transistor MO1k may be connected to a connection circuit 412k via the local node Qk. The first output transistor MO1k may control an electrical connection between the scan clock input terminal SINK and the output terminal OUTk, corresponding to the voltage of the local node Qk.

The second output transistor MO2k may be connected between the output terminal OUTk and the fourth power input terminal VIN4, and a gate electrode of the second output transistor MO2k may be connected to the second node QB. The second output transistor MO2k may control an electrical connection between the output terminal OUTk and the fourth power input terminal VIN4, corresponding to the voltage of the second node QB.

Each of the connection circuits 412a, 412b, . . . , and 412k may be connected between the first node Q and any one of the local nodes Qa, Qb, . . . , and Qk. The connection circuits 412a, 412b, . . . , and 412k may control electrical connections between the first node Q and the local nodes Qa, Qb, . . . , and Qk, corresponding to the voltage of the connection control line SCG. Each of the connection circuits 412a, 412b, . . . , and 412k may include any one of switching transistors MSa, MSb, . . . , and MSk and any one of boosting capacitors Cba, Cbb, . . . , and Cbk.

Each of the switching transistors MSa, MSb, . . . , and MSk may be connected between the first node Q and any one of the local nodes Qa, Qb, . . . , and Qk. A gate electrode of each of the switching transistors MSa, MSb, . . . , and MSk may be connected to the connection control line SCG. The switching transistors MSa, MSb, . . . , and MSk may control the electrical connections between the first node Q and the local nodes Qa, Qb, . . . , and Qk, corresponding to the voltage of the connection control line SCG.

Each of the boosting capacitors Cba, Cbb, . . . , and Cbk may be connected between any one of the local nodes Qa, Qb, . . . , and Qk and the voltage control line VCG. The boosting capacitors Cba, Cbb, . . . , and Cbk may control voltages of the local nodes Qa, Qb, . . . , and Qk, corresponding to the voltage of the voltage control line VCG.

The control circuit 410 may control the voltage of the connection control line SCG. To this end, the control circuit 410 may include a first control circuit 411 and a second control circuit 413.

The first control circuit 411 may be connected to the first power input terminal VIN1, the first carry input terminal CIN1, and the second carry input terminal CIN2, and supply the voltage of the first power source VGH1 to the connection control line SCG. The first control circuit 411 may include a first control transistor MC1 and a second control transistor MC2.

The first control transistor MC1 may be connected between the first power input terminal VIN1 and the connection control line SCG, and a gate electrode of the first control transistor MC1 may be connected to the first carry input terminal CIN1. The first control transistor MC1 may be turned on in case that a first carry signal CRi−1 is input to the first carry input terminal CIN1, to supply the voltage of the first power source VGH1 to the connection control line SCG. The first control transistor MC1 may be configured to include a plurality of transistors MC1a and MC1b connected in series to each other such that current leakage is reduced.

The second control transistor MC2 may be connected between the first power input terminal VIN1 and the connection control line SCG, and a gate electrode of the second control transistor MC2 may be connected to the second carry input terminal CIN2. The second control transistor MC2 may be turned on in case that a second carry signal CRi+1 is input to the second carry input terminal CIN2, to supply the voltage of the first power source VGH1 to the connection control line SCG. The second control transistor MC2 may be configured to include a plurality of transistors MC2a and MC2b connected in series to each other such that current leakage is reduced.

The second control circuit 413 may be connected to the third power input terminal VIN3, the third carry input terminal CIN3, and the voltage control line VCG, and supply the voltage of the third power source VGL2 to the connection control line SCG. The second control circuit 413 may include a first switching transistor MS1 and a second switching transistor MS2.

The first switching transistor MS1 may be connected between the third power input terminal VIN3 and the connection control line SCG, and a gate electrode of the first switching transistor MS1 may be connected to the third carry input terminal CIN3. The first switching transistor MS1 may be turned on in case that a third carry signal CRi+2 is input to the third carry input terminal CIN3, to supply the voltage of the third power source VGL2 to the connection control line SCG.

The second switching transistor MS2 may be connected between the third power input terminal VIN3 and the connection control line SCG, and a gate electrode of the second switching transistor MS2 may be connected to the voltage control line VCG. The second switching transistor MS2 may supply the voltage of the third power source VGL2 to the connection control line SCG while being turned on or turned off, corresponding to the voltage of the voltage control line VCG.

The transistors included in the stage circuit STi may be implemented with an N-type transistor, but the disclosure is not limited thereto. In addition, each of at least some of the transistors included in the stage circuit STi may be may be configured to include a plurality of transistors connected in series to each other.

FIG. 6 is a waveform diagram illustrating aspects of a method of driving the stage circuit shown in FIG. 5. In FIG. 6, portions indicated by S_CKa˜S_CKk may mean scan clock signals S_CKa to S_CKk. Although it is illustrated that some of the scan clock signals S_CKa to S_CKk overlap with each other, the disclosure is not limited thereto. According to some embodiments, the scan clock signals S_CKa to S_CKk may be supplied not to overlap with each other.

Referring to FIG. 6, the first carry clock signal C_CK1 and the second carry clock signal C_CK2 may have a same cycle and have a phase difference of 180 degrees. The first boosting clock signal B_CK1 and the second boosting clock signal B_CK2 may have a same cycle and may have a phase difference of 180 degrees. The carry clock signals C_CK1 and C_CK2 and the boosting clock signals B_CK1 and B_CK2 may have a same cycle.

During a cycle, a high voltage (e.g., a logic high level) of the carry clock signals C_CK1 and C_CK2 may be supplied for a time shorter than a time for which a low voltage (e.g., a logic low level) of the carry clock signals C_CK1 and C_CK2 is supplied. During a cycle, a low voltage (e.g., a logic low level) of the boosting clock signals B_CK1 and B_CK2 may be supplied for a time shorter than a time for which a high voltage (e.g., a logic high level) of the boosting clock signals B_CK1 and B_CK2 is supplied.

A low voltage of the first boosting clock signal B_CK1 may at least partially overlap with a low voltage of the first carry clock signal C_CK1, and a high voltage of the first boosting clock signal B_CK1 may at least partially overlap with a high voltage of the first carry clock signal C_CK1. The low voltage of the first boosting clock signal B_CK1 may at least partially overlap with a high voltage of the second carry clock signal C_CK2, and the high voltage of the first boosting clock signal B_CK1 may at least partially overlap with a low voltage of the second carry clock signal C_CK2.

A carry signal CR (CRi−1, CR, CRi+1, CRi+2, . . . ) may be set to a high voltage (e.g., a logic high level), and be synchronized with the high voltage of the carry clock signals C_CK1 and C_CK2. According to some embodiments, the stage circuits ST may output the high voltage of the carry clock signals C_CK1 and C_CK2 as the carry signal CR (CRi−1, CR, CRi+1, CRi+2, . . . ).

During a first period T1, by the driving circuit 402, the first node Q may have a high voltage (e.g., the first power source VGH1) and the second node QB may have a low voltage. In addition, the first carry signal CRi−1 may be input during the first period T1. According to some embodiments, the driving circuit 402 may set the first node Q to have a high voltage and set the second node QB to have a low voltage, corresponding to the first carry signal CRi−1 and the like.

In case that the first node Q has the high voltage, the first boosting transistor MB1 and the first carry transistor MA1 may be turned on. In case that the first boosting transistor MB1 is turned on, the boosting clock input terminal BCIN may be electrically connected to the voltage control line VCG (and the boosting output terminal BOUT). In case that the first carry transistor M1 is turned on, the carry clock input terminal CCIN may be electrically connected to the carry output terminal COUT.

In case that the first carry signal CR-1 is input, the first control transistor MC1 may be turned on, and accordingly, the voltage of the first power source VGH1 (e.g., a logic high level or a high voltage) may be supplied to the connection control line SCG.

In case that the high voltage is supplied to the connection control line SCG, the switching transistors MSa, MSb, . . . , and MSk may be turned on. In case that the switching transistors MSa, MSb, . . . , and MSk are turned on, the high voltage of the first node Q may be supplied to the local nodes Qa, Qb, . . . , and Qk. In case that the high voltage is supplied to the local nodes Qa, Qb, . . . , and Qk, the first output transistors MO1a, MO1b, . . . , MO1k may be turned on.

During a second period T2, the first boosting clock signal B_CK1 having a high level may be input to the boosting clock input terminal BCIN. The first boosting clock signal B_CK1 having the high level may be supplied to the voltage control line VCG via the first boosting transistor MB1, and accordingly, the voltage control line VCG may have a high voltage.

In case that the voltage control line VCG is set to the high voltage, the second switching transistor MS2 may be turned on. In case that the second switching transistor MS2 is turned on, the voltage of the third power source VGL2 may be supplied to the connection control line SCG. The third power source VGL2 may have a low voltage (e.g., a logic low level), and accordingly, the switching transistors MSa, MSb, . . . , and MSk may be turned off. In case that the switching transistors MSa, MSb, . . . , and MSk are turned off, the first node Q and the local nodes Qa, Qb, . . . , and Qk may be electrically interrupted from each other.

In case that the first boosting clock signal B_CK1 (e.g., a high voltage) is supplied to the voltage control line VCG, the voltage of the first node Q may be increased by the first capacitor C1. According to some embodiments, the voltage of the first node Q1 may be increased to a voltage approximately two time higher than the voltage of the first power source VGH1.

In case that the first boosting clock signal B_CK1 (e.g., a high voltage) is supplied to the voltage control line VCG, the voltages of the local nodes Qa, Qb, . . . , and Qk may be increased by the boosting capacitors Cba, Cbb, . . . , and Cbk, respectively. According to some embodiments, the voltage of each of the local nodes Qa, Qb, . . . , and Qk may be increased to a voltage approximately two time higher than the voltage of the first power source VGH1. In case that the voltage of each of the local nodes Qa, Qb, . . . , and Qk is increased to a voltage higher than the voltage of the first power source VGH1, a turn-on state of the first output transistors MO1a, MO1b, . . . , and MO1k may be stably maintained during the second period T2.

After that, the scan clock signals S_CKa, S_CKb, . . . , S_CKk having a high level may be input to the scan clock input terminals SINa, SINb, . . . , and SINK, respectively. The scan clock signals S_CKa, S_CKb, . . . , S_CKk having the high level may be supplied as enable scan signals to the output terminals OUTa, OUTb, . . . , and OUTk, respectively.

During the second period T2 in which the enable scan signals are output to the output terminals OUTa, OUTb, . . . , and OUTk, a tun-off state of the switching transistors MSa, MSb, . . . , and MSk may be maintained, and accordingly, an image with a uniform luminance may be displayed in the pixel unit 110.

For example, in case that the switching transistors MSa, MSb, . . . , and MSK are not provided, the voltage of each of the first node Q and the local nodes Qa, Qb, . . . , Qk may be changed by a parasitic capacitor of each of the first output transistors MO1a, MO1b, . . . , and MO1k during the second period T2 in which the enable scan signals are output. In particular, the first node Q (and the local nodes Qa, Qb, . . . , and Qk) may have different voltages, corresponding to a supply order of the enable scan signals, and accordingly, a luminance difference in a unit of a horizontal line may occur.

According to some embodiments of the present disclosure, the first node Q may maintain a certain voltage in case that the local nodes Qa, Qb, . . . , and Qk and the first node Q are electrically interrupted from each other by the switching transistors MSa, MSb, . . . and MSk during the period in which the enable scan signals are output. In addition, the voltages of the local nodes Qa, Qb, . . . , and Qk may be changed to a same (or substantially the same) voltage by the output of the enable scan signals, and accordingly, occurrence of the luminance difference in the unit of the horizontal line can be prevented or reduced.

After the second period T2, the second carry signal CRi+1 may be input to the second carry input terminal CIN2. According to some embodiments, the driving circuit 402 may supply a low voltage to the first node Q and supply a high voltage to the second node QB, corresponding to the second carry signal CRi+1.

In case that the second carry signal CRi+1 is input to the second carry input terminal CIN2, the second control transistor MC2 may be turned on. In case that the second control transistor MC2 is turned on, the voltage of the first power source VGH1 may be supplied to the connection control line SCG.

In case that the voltage of the first power source VGH1 is supplied to the connection control line SCG, the switching transistors MSa, MSb, . . . , and MSk may be turned on. In case that the switching transistors MSa, MSb, . . . , and MSk are turned on, the low voltage of the first node Q may be supplied to the local nodes Qa, Qb, . . . , and Qk. In case that the low voltage is supplied to the local nodes Qa, Qb, . . . , and Qk, the first output transistors MO1a, MO1b, . . . , and MO1k may be turned off.

After that, the third carry signal CRi+2 may be input to the third carry input terminal CIN3. In case that the third carry signal CRi+2 is input to the third carry input terminal CIN3, the first switching transistor MS1 may be turned on. In case that the first switching transistor MS1 is turned on, the voltage of the third power source VGL2 may be supplied to the connection control line SCG.

In case that the voltage of the third power source VGL2 is supplied to the connection control line SCG, the switching transistors MSa, MSb, . . . , and MSk may be turned off. In case that the switching transistors MSa, MSb, . . . , and MSk are turned off, the first node Q and the local nodes Qa, Qb, . . . , and Qk may be electrically interrupted from each other.

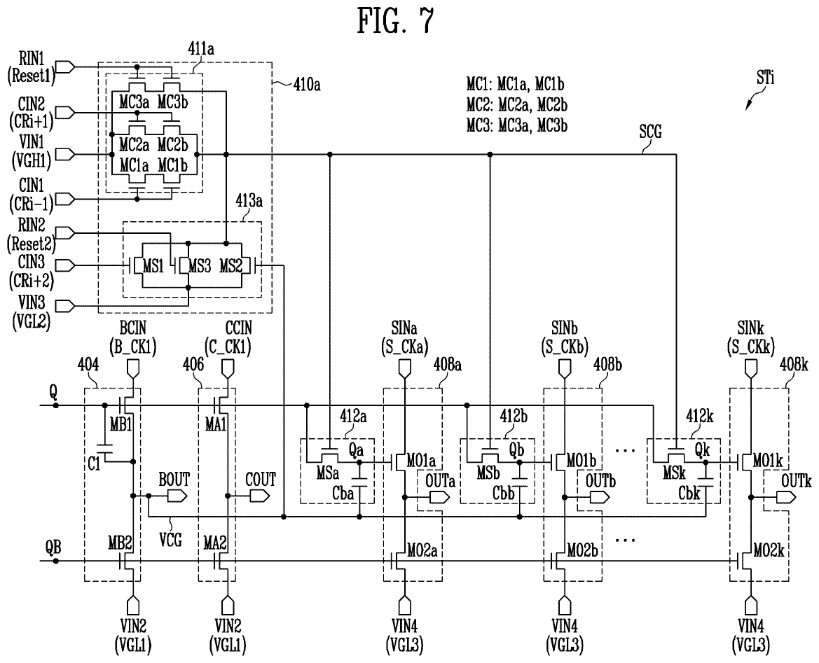

FIG. 7 is a diagram illustrating aspects of a circuit corresponding to each of the blocks shown in FIG. 4. In FIG. 7, some descriptions of components identical to the components shown in FIG. 5 may be omitted.

Referring to FIG. 7, a control circuit 410a may include a first control circuit 411a and a second control circuit 413a.

The first control circuit 411a may be connected to the first power input terminal VIN1, the first carry input terminal CIN1, the second carry input terminal CIN2, and the first reset input terminal RIN1, and supply the voltage of the first power source VGH1 to the connection control line SCG. The first control circuit 411a may include a first control transistor MC1, a second control transistor MC2, and a third control transistor MC3.

The third control transistor MC3 may be connected between the first power input terminal VIN1 and the connection control line SCG, and a gate electrode of the third control transistor MC3 may be connected to the first reset input terminal RIN1. The third control transistor MC3 may be turned on in case that a first reset signal Reset1 is input to the first reset input terminal RIN1, to supply the voltage of the first power source VGH1 to the connection control line SCG. The third control transistor MC3 may be configured to include a plurality of transistors MC3a and MC3b connected in series to each other such that current leakage is reduced.

The first reset input terminal RIN1 may be commonly connected to all the stage circuits ST. The first reset signal Reset1 may be supplied to set the voltage of the connection line SCG as the voltage of the first power source VGH1, and a supply timing may be controlled, if necessary.

The second control circuit 413a may be connected to the third power input terminal VIN3, the third carry input terminal CIN3, the voltage control line VCG, and a second reset input terminal RIN2, and supply the voltage of the third power source VGL2 to the connection control line SCG. The second control circuit 413a may include a first switching transistor MS1, a second switching transistor MS2, and a third switching transistor MS3.

The third switching transistor MS3 may be connected between the third power input terminal VIN3 and the connection control line SCG, and a gate electrode of the third switching transistor MS3 may be connected to the second reset input terminal RIN2. The third switching transistor MS3 may be turned on in case that a second reset signal Reset 2 is input to the second reset input terminal RIN2, to supply the voltage of the third power source VGL2 to the connection control line SCG.

The second reset input terminal RIN2 may be commonly connected to all the stage circuits ST. The second reset signal Reset2 may be supplied to set the voltage of the connection control line SCG as the voltage of the third power source VGL2, and a supply timing may be controlled, if necessary.

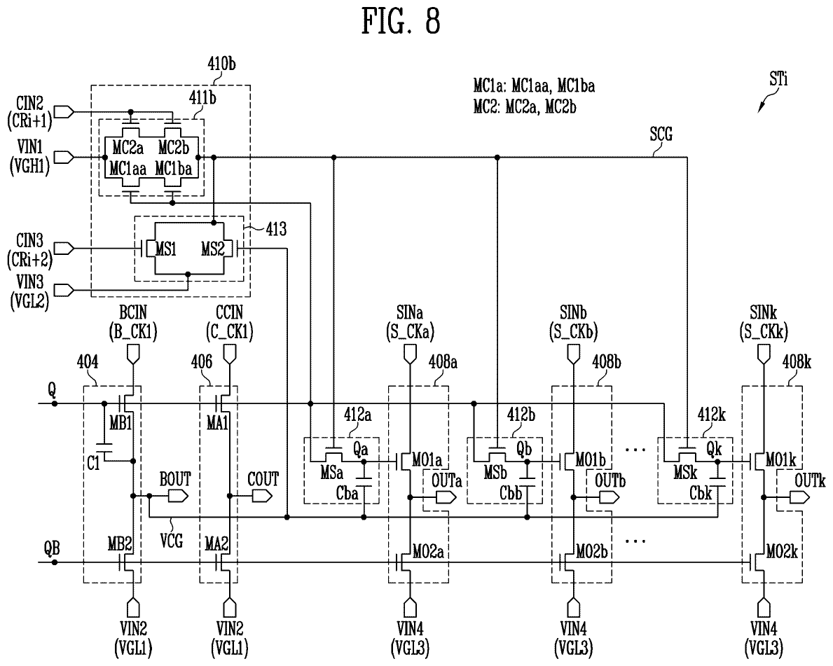

FIG. 8 is a diagram illustrating aspects of a circuit corresponding to each of the blocks shown in FIG. 4. In FIG. 8, some descriptions of components identical to the components shown in FIG. 5 may be omitted.

Referring to FIG. 8, a control circuit 410b may include a first control circuit 411b and a second control circuit 413.

The first control circuit 411b may be connected to the first power input terminal VIN1 and the second carry input terminal CIN2, and supply the voltage of the first power source VGH1 to the connection control line SCG.

The first control circuit 411b may include a first control transistor MC1a and a second control transistor MC2.

The first control transistor MC1a may be connected between the first power input terminal VIN1 and the connection control line SCG, and a gate electrode of the first control transistor MC1a may be connected to the first node Q. The first control transistor MC1a may supply the voltage of the first power source VGH1 to the connection control line SCG while being turned on or turned off, corresponding to the voltage of the first node Q. The first control transistor MC1a may be configured to include a plurality of transistors MC1aa and MC1ba connected in series to each other such that current leakage is reduced.

Referring to FIGS. 6 and 8, during the first period T1, the first node Q may have a high voltage and the second node QB may have a low voltage.

In case that the first node Q has the high voltage, the first control transistor MC1a may be turned on. In case that the first control transistor MC1a is turned on, the voltage of the first power source VGH1 (e.g., a high voltage) may be supplied to the connection control line SCG.

In case that the voltage of the first power source VGH1 is supplied to the connection control line SCG, the switching transistors MSa, MSb, . . . , and MSk may be turned on. In case that the switching transistors MSa, MSb, . . . , and MSk are turned on, the high voltage of the first node Q may be supplied to the local nodes Qa, Qb, . . . , and Qk. In case that the high voltage is supplied to the local nodes Qa, Qb, . . . , and Qk, the first output transistors MO1a, MO1b, . . . , and MO1k may be turned on.

During the second period T2, the voltage control line VCG may have a high voltage, and accordingly, the second switching transistor MS2 may be turned on. In case that the second switching transistor MS2 is turned on, the voltage of the third power source VGL2 may be supplied to the connection control line SCG. Therefore, the connection control line SCG may be decreased to a voltage (e.g., the voltage of the third power source VGL2) lower than the voltage of the first power source VGH1, and accordingly, the switching transistors MSa, MSb, . . . , and MSk may be turned off.

During the second period T2, a turn-on state of the first control transistor MC1a may be maintained. The first control transistor MC1a may have a relatively high resistance value, as compared with the second switching transistor MS2, because the first control transistor MC1a is configured to include the plurality of transistors MC1aa and MC1ba connected in series to each other. Therefore, the voltage of the connection line SCG may be decreased to the voltage of the third power source VGL2 during the second period T2.

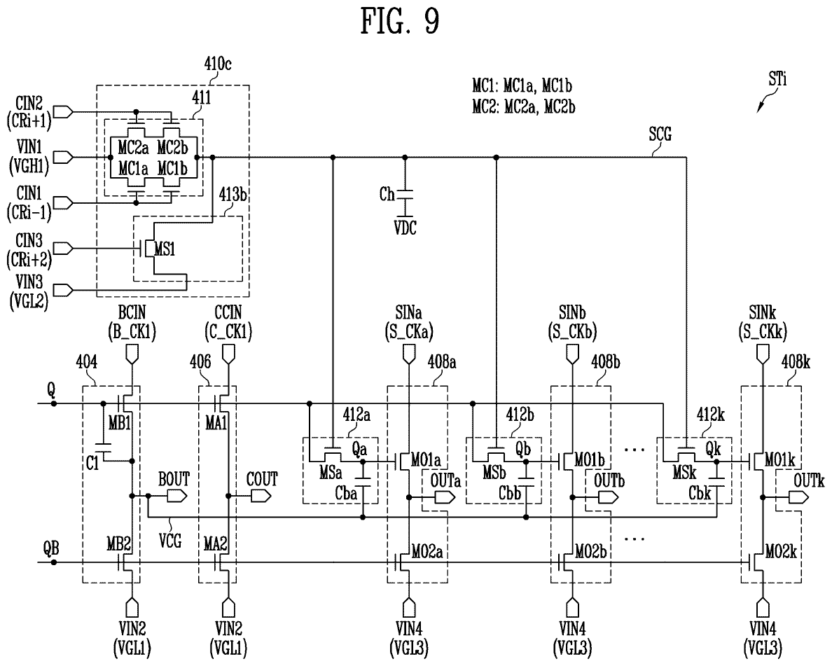

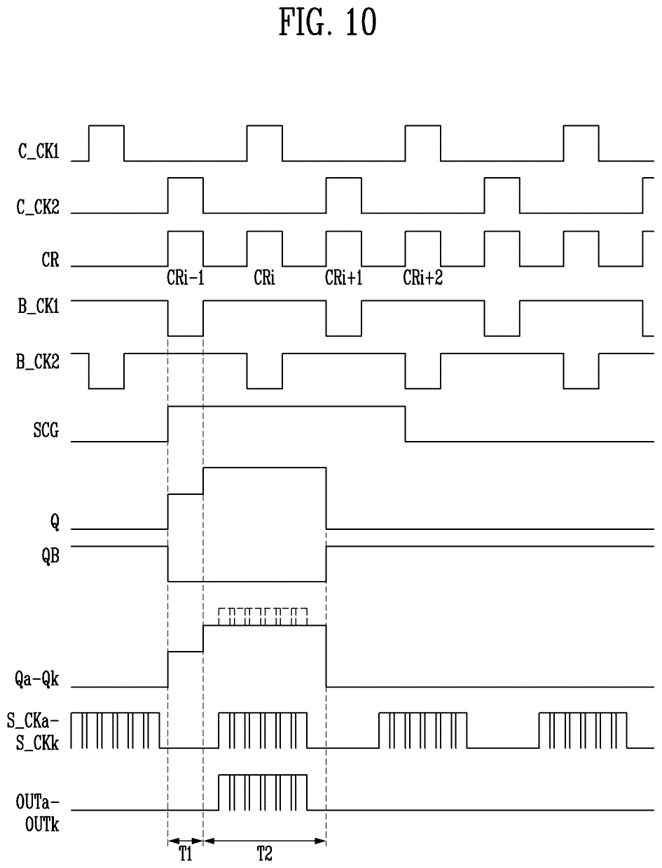

FIG. 9 is a diagram illustrating aspects of a circuit corresponding to each of the blocks shown in FIG. 4. FIG. 10 is a waveform diagram illustrating a method of driving a stage circuit shown in FIG. 9. In FIGS. 9 and 10, some descriptions of components identical to the components shown in FIG. 5 may be omitted.

Referring to FIG. 9, a control circuit 410c may include a first control circuit 411 and a second control circuit 413b.

The second control circuit 413b may be connected to the third power input terminal VIN3 and the third carry input terminal CIN3, and supply the voltage of the third power source VGL2 to the connection control line SCG. The second control circuit 413b may include a first switching transistor MS1. In the second control circuit 413b shown in FIG. 9, the second switching transistor MS2 may be omitted, as compared with the second control circuit 413 shown in FIG. 5.

Additionally, a stage circuit STi may include a holding capacitor Ch connected between the connection control line SCG and a constant voltage source VDC. The holding capacitor Ch may constantly maintain the voltage of the connection control line SCG. The constant voltage source VDC may be a power source which maintains a constant voltage. According to some embodiments, the constant voltage source VDC may be set as any one of the power sources VGH1, VGH2, VGL1, VGL2, and VGL3 input to the stage circuit STi. The holding capacitor Ch may be commonly applied to various embodiments included in the disclosure.

Referring to FIGS. 9 and 10, during a first period T1, the first node Q may have a high voltage and the second node QB may have a low voltage.

During the first period T1, the first control transistor MC1 may be turned on by the first carry signal CRi−1. In case that the first control transistor MC1 is turned on, the voltage of the first power source VGH1 (e.g., a high voltage) may be supplied to the connection control line SCG.

In case that the voltage of the first power source VGH1 is supplied to the connection control line SCG, the switching transistors MSa, MSb, . . . , and MSk may be turned on. In case that the switching transistors MSa, MSb, . . . , and MSk are turned on, the high voltage of the first node Q may be supplied to the local nodes Qa, Qb, . . . , and Qk. In case that the high voltage is supplied to the local nodes Qa, Qb, . . . , and Qk, the first output transistors MO1a, MO1b, . . . , and MO1k may be turned on.

During a second period T2, a boosting signal (or the first boosting clock signal B_CK1 may be supplied to the voltage control line VCG. In case that the boosting signal is supplied to the voltage control line VCG, the voltage of the first node Q may be increased to a voltage approximately two times higher than the voltage of the first power source VGH1 by the first capacitor C1. In case that the boosting signal is supplied to the voltage control line VCG, the voltage of each of the local nodes Qa, Qb, . . . , and Qk may be increased to a voltage approximately two times higher than the voltage of the first power source VGH1 by any one of the boosting capacitors Cba, Cbb, . . . , and Cbk.

During the second period T2, the voltage of the connection control line SCG may be maintained as the voltage of the first power source VGH1. Each of the first node Q and the local nodes Qa, Qb, . . . , and Qk may have a voltage higher than the voltage of the first power source VGH1, and accordingly, the switching transistors MSa, MSb, . . . , and MSk may be turned off during the second period T2.

The holding capacitor Ch may maintain the voltage of the connection control line SCG as approximately the voltage of the first power source VGH1 during the second period T2, and accordingly, a turn-off state of the switching transistors MSa, MSb, . . . , and MSk may be stably maintained.

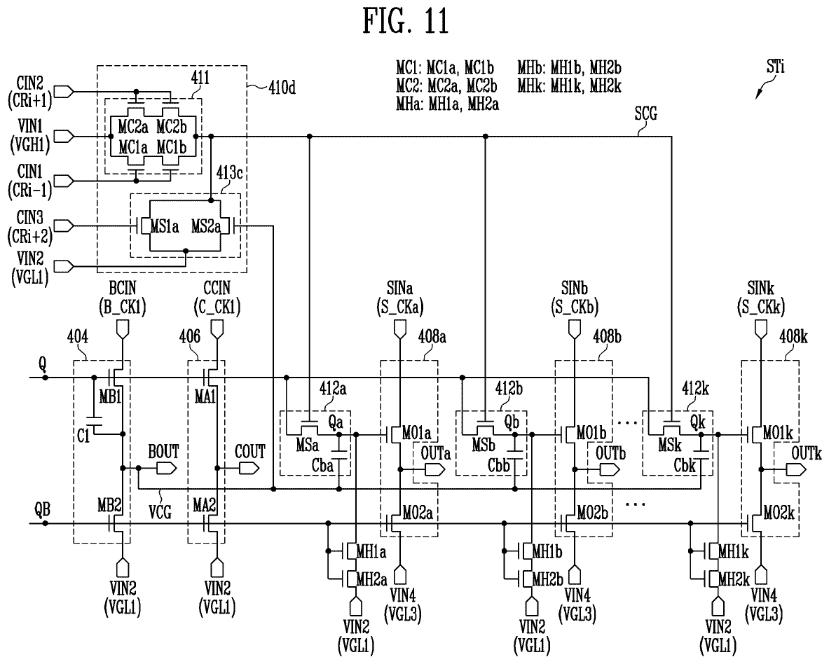

FIG. 11 is a diagram illustrating aspects of a circuit corresponding to each of the blocks shown in FIG. 4. In FIG. 11, some descriptions of components identical to the components shown in FIG. 5 may be omitted.

Referring to FIG. 11, a control circuit 410d may include a first control circuit 411 and a second control circuit 413c.

The second control circuit 413c may be connected to the second power input terminal VIN2, the third carry input terminal CIN3, and the voltage control line VCG, and supply the voltage of the second power source VGL1 to the connection control line SCG. The second control circuit 413c may include a first switching transistor MS1a and a second switching transistor MS2a.

The first switching transistor MS1a may be connected between the second power input terminal VIN2 and the connection control line SCG, and a gate electrode of the first switching transistor MS1a may be connected to the third carry input terminal CIN3. The first switching transistor MS1a may be turned on in case that the third carry signal CRi+2 is input to the third carry input terminal CIN3, to supply the voltage of the second power source VGL1 to the connection control line SCG.

The second switching transistor MS2a may be connected between the second power input terminal VIN2 and the connection control line SCG, and a gate electrode of the second switching transistor MS2a may be connected to the voltage control line VCG. The second switching transistor MS2a may supply the voltage of the second power source VGL1 to the connection control line SCG while being turned on or turned off, corresponding to the voltage of the voltage control line VCG.

The second control circuit 413c shown in FIG. 11 may supply the voltage of the second power source VGL1 to the connection control line SCG, and the second control circuit 413 shown in FIG. 5 may supply the voltage of the third power source VGL2 to the connection control line SCG. The second power source VGL1 and the third power source VGL2 may have a logic low level, and operation processes may be the same (or substantially the same).

Additionally, a stage circuit STi may include holding transistors MHa, MHb, . . . , and MHk connected between the respective local nodes Qa, Qb, . . . , and Qk and the second power input terminal VIN2. A gate electrode of each of the holding transistors MHa, MHb, . . . , and MHk may be connected to the second node QB. The holding transistors MHa, MHb, . . . , and MHK may be turned on in case that the second node QB has a high voltage, to supply the voltage of the second power source VGL1 to the local nodes Qa, Qb, . . . , and Qk. Each of the holding transistors MHa, MHb, . . . , and MHk may be configured to include a plurality of transistors (MHa: MH1a and MH2a, MHb: MH1b and MH2b, . . . , or MHK: MH1k and MH2k) connected in series to each other such that current leakage is reduced. The holding transistors MHa, MHb, . . . , and MHk may be commonly applied to various embodiments included in the disclosure.

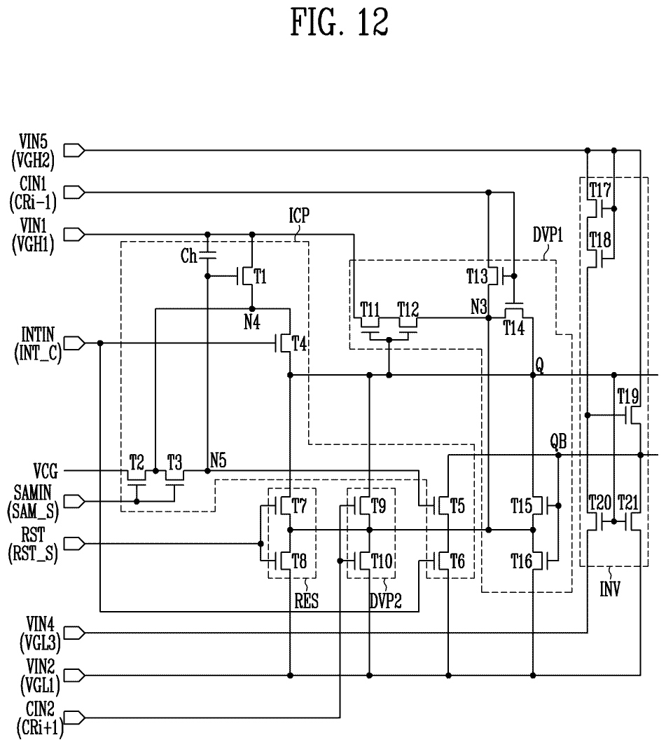

FIG. 12 is a diagram illustrating aspects of the driving circuit shown in FIG. 4.

Referring to FIG. 12, a driving circuit 402 according to some embodiments of the present disclosure may include an initialization control circuit ICP, a reset circuit RES, a first driving circuit DVP1, a second driving circuit DVP2, and an inverter circuit INV.

The inverter circuit INV may control the voltage of the second node QB, corresponding to the voltage of the first node Q. According to some embodiments, the inverter circuit INV may set the voltage of the second node QB as a low voltage (or a high voltage) in case that the voltage of the first node Q is the high voltage (or the low voltage).

To this end, the inverter circuit INV may include a seventeenth transistor T17, an eighteenth transistor T18, a nineteenth transistor T19, a twentieth transistor T20, and a twenty-first transistor T21.

The seventeenth transistor T17 and the eighteenth transistor T18 may be connected in series between the fifth power input terminal VIN5 and a gate electrode of the nineteenth transistor T19. A gate electrode of each of the seventeenth transistor T17 and the eighteenth transistor T18 may be connected to the fifth power input terminal VIN5. Each of the seventeenth transistor T17 and the eighteenth transistor T18 may be diode-connected such that a current can flow from the fifth power input terminal VIN5 to the gate electrode of the nineteenth transistor T19.

The twentieth transistor T20 may be connected between the gate electrode of the nineteenth transistor T19 and the fourth power input terminal VIN4. A gate electrode of the twentieth transistor T20 may be connected to the first node Q.

The twenty-first transistor T21 may be connected between the second node QB and the second power input terminal VIN2. A gate electrode of the twenty-first transistor T21 may be connected to the first node Q.

The nineteenth transistor T19 may be connected between the fifth power input terminal VIN5 and the second node QB. The gate electrode of the nineteenth transistor T19 may be connected to a common node between the eighteenth transistor T18 and the twentieth transistor T20.

The first driving circuit DVP1 may supply a high voltage to the first node Q in case that the first carry signal CRi−1 is input from the first carry input terminal CIN1. To this end, the first driving circuit DVP1 may include an eleventh transistor T11, a twelfth transistor T12, a thirteenth transistor T13, a fourteenth transistor T14, a fifteenth transistor T15, and a sixteenth transistor T16.

The eleventh transistor T11 and the twelfth transistor T12 may be connected in series between the first power input terminal VIN1 and a third node N3. A gate electrode of each of the eleventh transistor T11 and the twelfth transistor T12 may be connected to the first node Q. The eleventh transistor T11 and the twelfth transistor T12 may control an electrical connection between the first power input terminal VIN1 and the third node N3 while being turned on or turned off, corresponding to the voltage of the first node Q.

The thirteenth transistor T13 may be connected between the first carry input terminal CIN1 and the third node N3. A gate electrode of the thirteenth transistor T13 may be connected to the first carry input terminal CIN1. The thirteenth transistor T13 may be diode-connected such that a current can flow from the first carry input terminal CIN1 to the third node N3.

The fourteenth transistor T14 may be connected between the third node N3 and the first node Q. A gate electrode of the fourteenth transistor T14 may be connected to the first carry input terminal CIN1.

The fifteenth transistor T15 may be connected between the first node Q and the third node N3. A gate electrode of the fifteenth transistor T15 may be connected to the second node QB.

The sixteenth transistor T16 may be connected between the third node N3 and the second power input terminal VIN2. A gate electrode of the sixteenth transistor T16 may be connected to the second node QB.

The second driving circuit DVP2 may control the voltage of the first node Q, based on the second carry signal CRi+1 input to the second carry input terminal CIN2. To this end, the second driving circuit DVP2 may include a ninth transistor T9 and a tenth transistor T10.

The ninth transistor T9 may be connected between the first node Q and the third node N3. A gate electrode of the ninth transistor T9 may be connected to the second carry input terminal CIN2.

The tenth transistor T10 may be connected between the third node N3 and the second power input terminal VIN2. A gate electrode of the tenth transistor T10 may be connected to the second carry input terminal CIN2.

The reset circuit RES may control the voltage of the first node Q, based on the reset signal RST_S input to the reset input terminal RST. To this end, the reset circuit RES may include a seventh transistor T7 and an eighth transistor T8.

The seventh transistor T7 may be connected between the first node Q and the third node N3. A gate electrode of the seventh transistor T7 may be connected to the reset input terminal RST.

The eighth transistor T8 may be connected between the third node N3 and the second power input terminal VIN2. A gate electrode of the eighth transistor T8 may be connected to the reset input terminal RST.

The seventh transistor T7 and the eighth transistor T8 may be turned on in case that the reset signal RST_S is input, to supply the voltage of the second power source VGL1 to the first node Q. The reset signal RST_S may be supplied to initialize the stage circuit. According to some embodiments, the reset signal RST_S may be supplied after the display device is turned on.

The initialization control circuit ICP may supply an enable first scan signal SC to a scan line located on a specific horizontal line and supply an enable second scan signal IS to an initialization line located on the specific horizontal line during a sensing period, based on the sampling signal SAM_S input to the sampling input terminal SAMIN and the initialization control signal INT_C input to the initialization terminal INTIN. To this end, the initialization control circuit ICP may include a first transistor T1, a second transistor T2, a third transistor T3, a fourth transistor T4, a fifth transistor T5, and a sixth transistor T6.

The first transistor T1 may be connected between the first power input terminal VIN1 and a fourth node N4. A gate electrode of the first transistor T1 may be connected to a fifth node N5.

The second transistor T2 and the third transistor T3 may be connected in series between the voltage control line VCG and the fifth node N5. A gate electrode of each of the second transistor T2 and the third transistor T3 may be connected to the sampling input terminal SAMIN. A common node of the second transistor T2 and the third transistor T3 may be connected to the fourth node N4.

The fourth transistor T4 may be connected between the fourth node N4 and the first node Q. A gate electrode of the fourth transistor T4 may be connected to the initialization terminal INTIN.

The fifth transistor T5 and the sixth transistor T6 may be connected in series between the second node QB and the second power input terminal VIN2. A gate electrode of the fifth transistor T5 may be connected to the fifth node N5, and a gate electrode of the sixth transistor T6 may be connected to the initialization terminal INTIN.

A holding capacitor Ch may be connected between the first power input terminal VIN1 and the fifth node N5. The holding capacitor Ch may store a voltage of the fifth node N5.

However, embodiments of the present disclosure are not limited thereto, and the driving circuit 402 may be configured with various circuits currently known in the art. According to some embodiments, the driving circuit 402 may be configured with various circuits currently known in the art, which can control the first node Q and the second node QB.

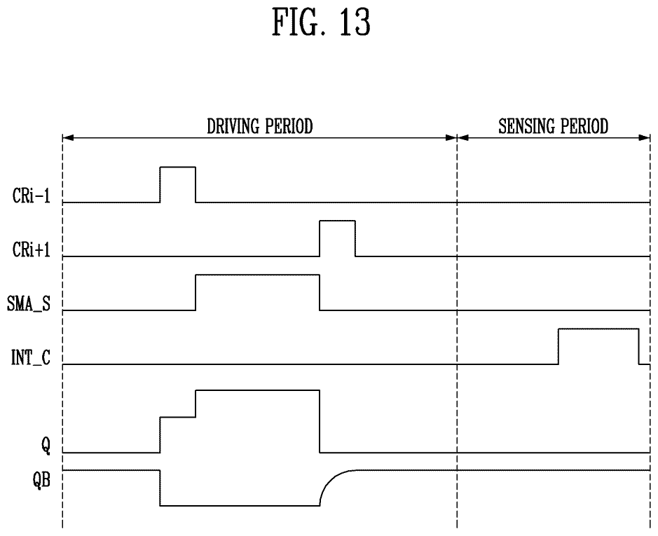

FIG. 13 is a waveform diagram illustrating an operation process of the driving circuit shown in FIG. 12. In FIG. 13, some descriptions of portions described with reference to FIG. 6 may be omitted or simplified.

Referring to FIG. 13, during a driving period, the first carry signal CRi−1 may be input to the first carry input terminal CIN1.

In case that the first carry signal CRi−1 is input, the thirteenth transistor T13 and the fourteenth transistor T14 may be turned on, and accordingly, the voltage of the first node Q may be increased to a high voltage. In case that the voltage of the first node Q is increased to the high voltage, the eleventh transistor T11 and the twelfth transistor T12 may be turned on, and the voltage of the first power source VGH1 may be supplied to the third node N3. The third node N3 may be electrically connected to the first node Q via the fourteenth transistor T14, and accordingly, the first node Q may have approximately the voltage of the first power source VGH1.

In case that the first node Q has the high voltage, the twentieth transistor T20 and the twenty-first transistor T21 may be turned on. In case that the twentieth transistor T20 is turned on, the voltage of the fourth power source VGL3 may be supplied to the gate electrode of the nineteenth transistor T19, and accordingly, the nineteenth transistor T19 may be turned off. In case that the twenty-first transistor T21 is turned on, the voltage of the second power source VGL1 may be supplied to the second node QB, and accordingly, the second node QB may have a low voltage.

During the driving period, the sampling signal SAM_S may be input to the sampling input terminal SAMIN. According to some embodiments, the sampling signal SAM_S may be supplied during a period in which an enable first scan signal SC and an enable second scan signal IS are output from a specific stage circuit. In case that the sampling signal SAM_S is supplied, a second transistor T2 and a third transistor T3, which are included in the specific stage circuit, may be turned on.

In case that the second transistor T2 and the third transistor T3 are turned on, the voltage control line VCG and the fifth node N5 may be electrically connected to each other. Therefore, the voltage of the voltage control line VCG (or a boosting signal), i.e., a high voltage may be supplied to the fifth node N5, and a high voltage (e.g., a voltage corresponding to turn-on of the first transistor T1) may be stored in the holding capacitor Ch.

In case that the sampling signal SAM_S is supplied, a second transistor T2 and a third transistor T3, which are not included in the specific stage circuit, e.g., which are included in each of the other stage circuits, may also be turned on.

In case that the second transistor T2 and the third transistor T3 are turned on, a voltage control line VCG and a fifth node N5, which are included in each of the other stage circuits, may be electrically connected to each other. The boosting signal is not supplied to the voltage control line VCG included in each of the other stage circuits, and accordingly, a voltage corresponding to turn-off of the first transistor T1 may be stored in a holding capacitor Ch included in each of the other stage circuits.

After that, the second carry signal CRi+1 may be input to the second carry input terminal CIN2. In case that the second carry signal CRi+1 is input, the ninth transistor T9 and the tenth transistor T10 may be turned on. In case that the ninth transistor T9 and the tenth transistor T10 are turned on, the voltage of the second power source VGL1 may be supplied to the first node Q. Therefore, the voltage of the first node Q may be set as a low voltage.

In case that the voltage of the first node Q is set as the low voltage, the twentieth transistor T20 and the twenty-first transistor T21 may be turned off. The voltage of the gate electrode of the nineteenth transistor T19 may be increased to the voltage of the fifth power source VGH2 by the seventeenth transistor T17 and the eighteenth transistor T18, each of which is diode-connected, and accordingly the nineteenth transistor T19 may be turned on. In case that the nineteenth transistor T19 is turned on, the voltage of the fifth power source VGH2 (i.e., a high voltage) may be supplied to the second node QB.

In case that the voltage of the second node QB is set as a high voltage, the fifteenth transistor T15 and the sixteenth transistor T16 may be turned on. In case that the fifteenth transistor T15 and the sixteenth transistor T16 are turned on, the voltage of the second power source VGL1 may be supplied to the first node Q, and accordingly, the voltage of the first node Q may be maintained as the low voltage.

During a sensing period, the initialization control signal INT_C may be input to the initialization terminal INTIN. In case that the initialization control signal INT_C is input to the initialization terminal INTIN, a fourth transistor T4 and a sixth transistor T6, which are included in each of all the stage circuits, may be turned on.

A turn-off state of each of a first transistor T1 and a fifth transistor T5, which are included in each of the other stage circuits, in which a turn-off voltage is charged in the holding capacitor Ch, may be maintained. Accordingly, the low voltage of the first node Q and the high voltage of the second node QB may be maintained.

A first transistor T1 and a fifth transistor T5, which are included in the specific stage circuit, in which a turn-on voltage is charged in the holding capacitor Cb, may be turned on. The voltage of the first power source VGH1 may be supplied to the first node Q via the first transistor T1 and the fourth transistor T4 because the fourth transistor T4 is set to be in a turn-on state. In addition, the voltage of the third power source VGL1 may be supplied to the second node QB via the sixth transistor T6 and the fifth transistor T5 because the sixth transistor T6 is set to be in a turn-on state.

After that, at least one of the scan clock signals S_CKa to S_CKk is supplied to the specific stage circuit, so that the enable first scan signal SC and/or the enable second scan signal IS can be supplied to a specific horizontal line during the sensing period.

Additionally, the driving circuit 402 shown in FIG. 12 may be applied while being combined with the control circuit 410a shown in FIG. 7. According to some embodiments, the voltage of the first power source VGH1 may be supplied to the connection control line SCG by inputting the first reset signal Reset1 to the first reset input terminal RIN1 during at least a partial period of the sensing period. In case that the voltage of the first power source VGH1 is supplied to the connection control line SCG, the switching transistors MSa to MSk may be turned on, and accordingly, the local nodes Qa to Qk and the first node Q may be electrically connected to each other. In addition, the voltage of the third power source VGL2 may be supplied to the connection control line SCG by inputting the second reset signal Reset2 to the second reset input terminal RIN2.

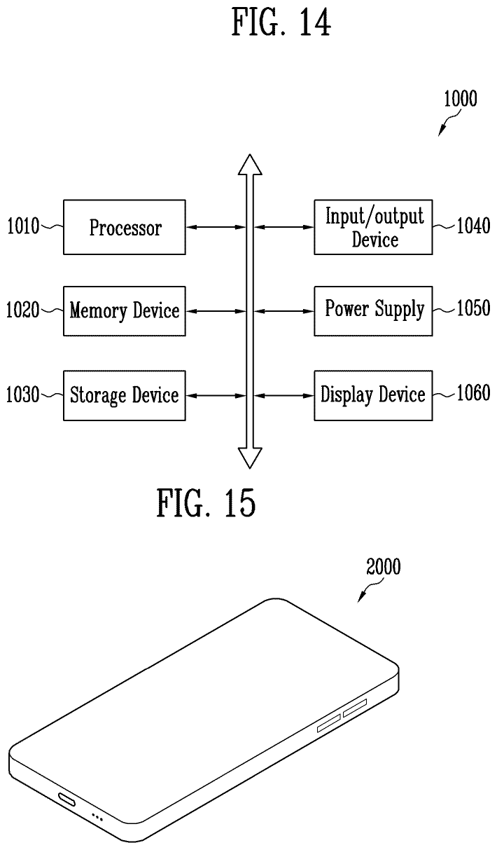

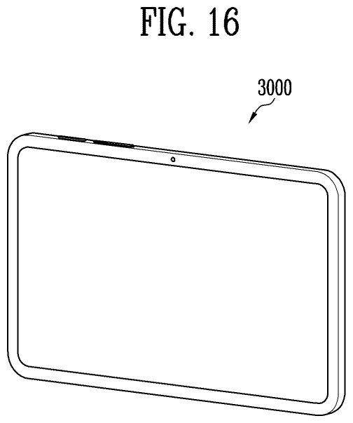

FIG. 14 is a block diagram illustrating aspects of an electronic device including the display device shown in FIG. 1. FIG. 15 is a perspective view illustrating an example of a smartphone capable of being implemented using the electronic device shown in FIG. 14. FIG. 16 is a perspective view illustrating an example of a tablet computer capable of being implemented using the electronic device shown in FIG. 14.

Referring to FIG. 14, an electronic device 1000 may include a processor 1010, a memory device 1020, a storage device 1030, an input/output device 1040, a power supply 1050, and a display device 1060.

According to some embodiments, as shown in FIG. 15, the electronic device 1000 may be implemented as a smartphone 2000. In other embodiments, as shown in FIG. 16, the electronic device 1000 may be implemented as a tablet computer 3000. However, this is merely illustrative, and the electronic device 1000 is not limited thereto. For example, the electronic device 1000 may be a computer device or an electronic device, which includes the display device 1060, such as a digital television (TV), a 3D TV, a personal computer (PC), a household electronic device, a laptop computer, a mobile phone, a videophone, a smart pad, a smart watch, a head mounted display device, a personal digital assistant (PDA), a portable multimedia player (PMP), a digital camera, a music player, a portable game console, or a navigation system.

The processor 1010 may perform various tasks and calculations. According to some embodiments, the processor 1010 may include an application processor, a graphic processing unit, a microprocessor, a central processing unit (CPU), and the like. The processor 1010 may be connected to other components of the electronic device 1000 through a bus system. The processor 1010 may provide the display device 1060 with a data stream to be displayed in the display device 1060. The data stream may be provided as the input data Din shown in FIG. 1 to the display device 1060. The processor 1010 may further transmit the control signals CS shown in FIG. 1 to the display device 1060.

The memory device 1020 may be provided as a working memory and/or a buffer memory of the electronic device 1000 and/or the processor 1010. According to some embodiments, the memory device 1020 may include volatile memory devices, such as a Dynamic Random Access Memory (DRAM), a Static Random Access Memory (SRAM), and a mobile DRAM.

The storage device 1030 may store data under the control of the processor 1010. The storage device 1030 may include a nonvolatile storage medium which sustains data even though power of the electronic device 1000 is interrupted. According to some embodiments, the storage device 1030 may include a Solid State Drive (SSD), a Hard Disk Drive (HDD), and the like.

The input/output device 1040 may include user input devices, such as a keyboard, a keypad, a touch pad, a touch screen, and a mouse, and output devices such as a speaker and a printer.

The power supply 1050 may supply power necessary for an operation of the electronic device 1000. For example, the power supply 1050 may be a power management integrated circuit (PMIC). For example, the power supply 1050 may include a battery.

The display device 1060 may display an image under the control of the processor 1010. The display device 1060 may be connected to other components of the electronic device 1000 through the bus system and/or another communication link. The display device 1060 may be implemented as the display device 100 shown in FIG. 1. The display device 1060 may include the scan driver 130 shown in FIG. 3. The display device 1060 may include the stage circuit shown in any one of FIGS. 4, 5, 7 to 9, 11, and 12.

In the stage circuit and the display device including the same, and the electronic device in accordance with some embodiments of the disclosure, output circuits which output an enable scan signal, based on a voltage of a first node may be electrically interrupted from the first node in case that the enable scan signal is output. The output circuits may extract an enable scan signal, using a pre-stored voltage, and accordingly, occurrence of a luminance difference in a unit of a horizontal line can be prevented or reduced.

Aspects of some embodiments have been disclosed herein, and although specific terms are employed, they are used and are to be interpreted in a generic and descriptive sense only and not for purpose of limitation. In some instances, as would be apparent to one of ordinary skill in the art as of the filing of the application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the disclosure as set forth in the following claims, and their equivalents.

What is claimed is:

1. A stage circuit comprising:
a driving circuit connected to a first power input terminal configured to receive a first power source and a second power input terminal configured to receive a second power source, the driving circuit being configured to control a voltage of a first node;
a plurality of first output circuits configured to receive any one of a plurality of scan clock signals, the plurality of first output circuits being configured to output enable scan signals, based on a voltage of any one of local nodes; and
connection circuits connected between the respective local nodes and the first node, the connection circuits being configured to control electrical connections between the first node and the local nodes, corresponding to a voltage input to a connection control line,
wherein the connection circuits are configured to electrically connect the first node and the local nodes to each other during a first period in a period in which the first node has a voltage of a first level or higher, and to electrically interrupt the first node and the local nodes from each other during a second period after the first period in the period in which the first node has the voltage of the first level or higher.

2. The stage circuit of claim 1, wherein the first level is a logic high level.

3. The stage circuit of claim 1, wherein the driving circuit is further configured to control a voltage of a second node, and the first output circuits are electrically connected to the second node.

4. The stage circuit of claim 3, further comprising a holding transistor connected between each of the local nodes and the second power input terminal, the holding transistor including a gate electrode connected to the second node.

5. The stage circuit of claim 3, further comprising a second output circuit connected between a carry clock input terminal to which a carry clock signal is input and the second power input terminal, the second output circuit connecting a carry output terminal to the carry clock input terminal or the second power input terminal, based on the voltage of each of the first node and the second node.

6. The stage circuit of claim 5, wherein the second output circuit includes:
a first carry transistor connected between the carry clock input terminal and the carry output terminal, the first carry transistor including a gate electrode connected to the first node; and
a second carry transistor connected between the carry output terminal and the second power input terminal, the second carry transistor including a gate electrode connected to the second node.

7. The stage circuit of claim 3, wherein each of the first output circuits is connected to any one of output terminals, and the second period is a period in which any one of the scan clock signals is supplied as an enable scan signal to the output terminals in each of the first output circuits.

8. The stage circuit of claim 7, wherein each of the first output circuits includes:
a first output transistor connected between a scan clock input terminal to which any one of the scan clock signals is input and any one of the output terminals, the first output transistor including a gate electrode connected to any one of the local nodes; and
a second output transistor connected between a fourth power input terminal to which a fourth power source is input and any one of the output terminals, the second output transistor including a gate electrode connected to the second node.

9. The stage circuit of claim 3, further comprising:
a boosting circuit connected between a boosting clock input terminal configured to receive a boosting clock and the second power input terminal, the boosting circuit being configured to connect a voltage control line to the boosting clock input terminal or the second power input terminal, based on the voltage of each of the first node and the second node; and
a control circuit connected to the first power input terminal, third power input terminal to which a third power source having a voltage lower than a voltage of the first power source is input, and the connection control line, the control circuit controlling a voltage of the connection control line, corresponding to a plurality of carry signals supplied to carry input terminals.

10. The stage circuit of claim 9, wherein each of the connection circuits includes:
a switching transistor connected between any one of the local nodes and the first node, the switching transistor including a gate electrode connected to the connection control line; and
a boosting capacitor connected between any one of the local nodes and the voltage control line.

11. The stage circuit of claim 9, wherein the boosting circuit includes:
a first boosting transistor connected between the boosting clock input terminal and the voltage control line, the first boosting transistor including a gate electrode connected to the first node;
a second boosting transistor connected between the voltage control line and the second power input terminal, the second boosting transistor including a gate electrode connected to the second node; and
a first capacitor connected between the first node and the voltage control line.

12. The stage circuit of claim 9, wherein the control circuit includes:
a first control circuit connected to the first power input terminal and the connection control line, the first control circuit controlling an electrical connection between the first power input terminal and the connection control line, based on a first carry signal input to a first carry input terminal and a second carry signal input to a second carry input terminal; and
a second control circuit connected to the third power input terminal and the connection control line, the second control circuit controlling an electrical connection between the third power input terminal and the connection control line, based on a third carry signal input to a third carry input terminal.

13. The stage circuit of claim 12, wherein the first carry signal is a carry signal of a previous stage circuit, and the second carry signal and the third carry signal are carry signals of next stage circuits.

14. The stage circuit of claim 13, wherein, in case that the stage circuit is an ith (i is a natural number of 1 or more) stage circuit, the first carry signal is an (i−1)th carry signal, the second carry signal is an (i+1)th carry signal, and the third carry signal is an (i+2)th carry signal.

15. The stage circuit of claim 12, wherein the first control circuit includes:
a first control transistor connected between the first power input terminal and the connection control line; and
a second control transistor connected between the first power input terminal and the connection control line, the second control transistor including a gate electrode connected to the second carry input terminal.

16. The stage circuit of claim 15, wherein the first control circuit further includes a third control transistor connected between the first power input terminal and the connection control line, the third control transistor including a gate electrode connected to a first reset input terminal configured to receive a first reset signal.

17. The stage circuit of claim 16, wherein at least one of the first control transistor, the second control transistor, or the third control transistor is configured such that a plurality of transistors are connected in series to each other.

18. The stage circuit of claim 12, wherein the second control circuit includes a first switching transistor connected between the connection control line and the third power input terminal, the first switching transistor including a gate electrode connected to the third carry input terminal.

19. The stage circuit of claim 18, wherein the second control circuit further includes a second switching transistor connected between the connection control line and the third power input terminal, the second switching transistor including a gate electrode connected to the voltage control line.

20. An electronic device comprising:
a processor; and
a display device including pixels connected to scan lines and data lines and a scan driver configured to drive the scan lines,
wherein at least one stage circuit among stage circuits included in the scan driver includes:
a driving circuit configured to control a voltage of each of a first node and a second node;
first output circuits configured to receive any one of a plurality of scan clock signals, the first output circuits being configured to output any one of the scan clock signals as an enable scan signal, based on a voltage of any one of local nodes; and
connection circuits connected between the respective local nodes and the first node, the connection circuits configured to control electrical connection between the first node and the local nodes, and
wherein the connection circuits are configured to electrically interrupt the local nodes and the first node from each other during a period in which at least one of the scan clock signals is output in each of the first output circuits.
